(19) United States
(12) Patent Application Publication
(10) Pub. No.: US 2022/0327455 A1
(43) Pub. Date: Oct. 13, 2022

(54) INFORMATION PROCESSING SYSTEM AND INFORMATION PROCESSING METHOD

(71) Applicant: FRONTEO, Inc., Tokyo (JP)

(72) Inventors: Toru HISAMITSU, Tokyo (JP); Kazumi HASUKO, Tokyo (JP); Takayuki MIZUNO, Tokyo (JP)

(21) Appl. No.: 17/711,607

(22) Filed: Apr. 1, 2022

(30) Foreign Application Priority Data
Apr. 7, 2021 (JP) 2021-065428

(51) Int. Cl. G06Q 10/06

(52) U.S. Cl. CPC G06Q 10/06375

(57) ABSTRACT

An information processing system includes: an entity network obtaining unit configured to obtain an entity network; an influence level calculation unit configured to perform an influence level calculation process based on the entity network; a strategy determining unit configured to present strategies taken by the first entity and receive a selection of any of the presented strategies to determine a selected strategy; and a strategy interpretation unit configured to determine a constraint for the influence level calculation process based on the selected strategy; and an evaluation processing unit. The influence level calculation unit calculates a first influence level under no constraint and a second influence level under the constraint, and the evaluation processing unit evaluates the selected strategy on the basis of a comparison between the first influence level and the second influence level.

### CROSS-REFERENCE TO RELATED APPLICATION

The present application claims priority from Japanese Application JP2021-065428, the content of which is hereby incorporated by reference into this application.

### BACKGROUND OF THE INVENTION

### 1. Field of the Invention

The present invention relates to, for example, information processing systems and information processing methods.

### 2. Description of the Related Art

Techniques have been known that quantify what influential power an entity has on another entity. Entities in this context may be, for example, countries, businesses, and people.

As an example, Japanese Unexamined Patent Application Publication, JP2021-005298A discloses a technique of determining the influential power that an entity has on another entity even when the entities have complex mutual relationships. Complex relationships may be, for example, highly hierarchical and/or circular.

### SUMMARY OF THE INVENTION

To devise a strategy, entities including countries and businesses need to evaluate the effect of the strategy taking complex entity-to-entity relationships into account. Entities can employ various strategies, and entity-to-entity relationships can also change in different ways depending on strategies.

The present disclosure, in an aspect thereof, is directed to an information processing system including: an entity network obtaining unit configured to obtain an entity network of nodes corresponding to respective entities including a first entity and a second entity based on an investment relationship; an influence level calculation unit configured to implement an influence level calculation process of calculating an influence level on the second entity based on the entity network; a strategy determining unit configured to present strategies representing future actions taken by the first entity and receive a selection of any of the presented strategies to determine a selected strategy, a strategy interpretation unit configured to determine a constraint for the influence level calculation process based on the selected strategy; and an evaluation processing unit configured to evaluate the selected strategy based on a result of the influence level calculation process, wherein the influence level calculation unit calculates a first influence level that is the influence level under no constraint and a second influence level that is the influence level under the constraint, and the evaluation processing unit evaluates the selected strategy based on a comparison between the first influence level and the second influence level.

The present disclosure, in another aspect thereof, is directed to an information processing method including: obtaining an entity network of nodes corresponding to respective entities including a first entity and a second entity based on an investment relationship; presenting strategies representing future actions taken by the first entity; receiving a selection of any of the presented strategies to determine a selected strategy; determining a constraint based on the selected strategy; calculating, based on the entity network, a first influence level that is an influence level on the second entity under no constraint; calculating, based on the entity network, a second influence level that is an influence level on the second entity under the constraint; and evaluating the selected strategy based on a companion between the first influence level and the second influence level.

### BRIEF DESCRIPTION OF THE DRAWINGS

FIG. 1 shows an exemplary structure of a system including an information processing system.

FIG. 2 shows an exemplary structure of a server system.

FIG. 3 shows an exemplary structure of a terminal device.

FIG. 4 is a diagram of business ownership stake network analysis.

FIG. 5 is a diagram of supply chain analysis.

FIG. 6 is a diagram of people network analysis.

FIG. 7 is a diagram of SNS and news analysis.

FIG. 8 is a diagram of an exemplary entity network representing investment relationships.

FIG. 9 is a diagram of a process of calculating the NPI.

FIG. 10 is a flow chart representing a process in accordance with the present embodiment.

FIG. 11A shows an exemplary display screen for a user input of a strategy implementing entity.

FIG. 11B shows an exemplary display screen for a user input of an influenced entity.

FIG. 11C shows an exemplary display screen for a user input of a strategy.

FIG. 12A shows an exemplary display screen for a hostile strategy.

FIG. 12B shows an exemplary display screen for a hostile strategy.

FIG. 13 shows an exemplary display screen for a cooperative strategy.

FIG. 14 shows an exemplary display screen for a divestiture strategy.

FIG. 15A is a diagram of a constraint in a cooperative strategy.

FIG. 15B is a diagram of a constraint in a hostile strategy.

FIG. 16A is a diagram of a constraint in a takeover strategy.

FIG. 16B is a diagram of a constraint in a divestiture strategy.

FIG. 17 is a flow chart representing an influence level calculation process.

FIG. 18A is a flow chart representing an evaluation process.

FIG. 18B is a flow chart representing a path evaluation process.

FIG. 19 shows an exemplary display screen for presenting an evaluation result.

FIG. 20A is a flow chart representing an evaluation process.

FIG. 20B is a flow chart representing an evaluation process.

FIG. 21 shows an exemplary display screen for presenting an evaluation result.

FIG. 22 shows an exemplary display screen for presenting an evaluation result.

FIG. 23 is a flow chart representing a process in accordance with the present embodiment.

FIG. 24A shows an exemplary display screen for a user input of an evaluation criterion.

FIG. 24B shows an exemplary display screen for presenting a recommended strategy target entity.

### DETAILED DESCRIPTION OF THE INVENTION

The following will describe the present embodiment with reference to drawings. Identical and equivalent elements in the drawings are denoted by the same reference numerals, and description thereof is not repeated. The scope of the present invention is not unreasonably limited by the present embodiment described below. Not all the members described in the present embodiment are essential to the present disclosure.

### 1. OSINT System

### 1.1 Example of System Structure

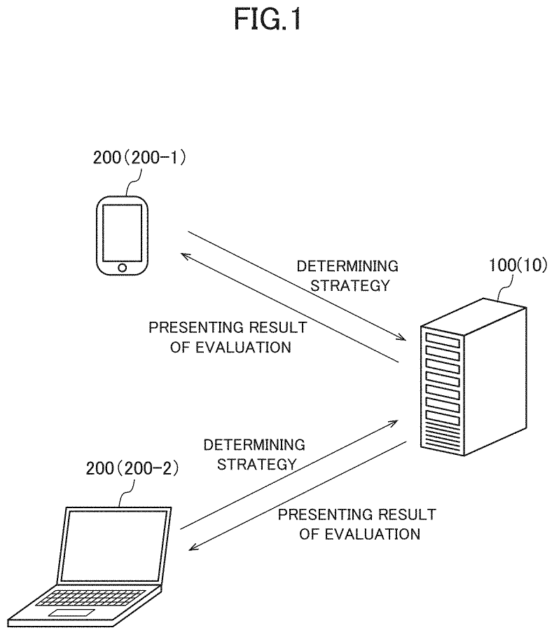

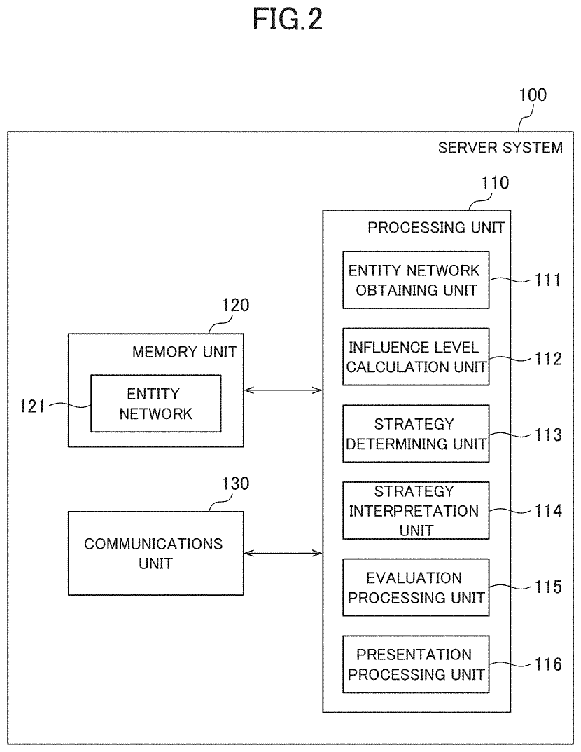

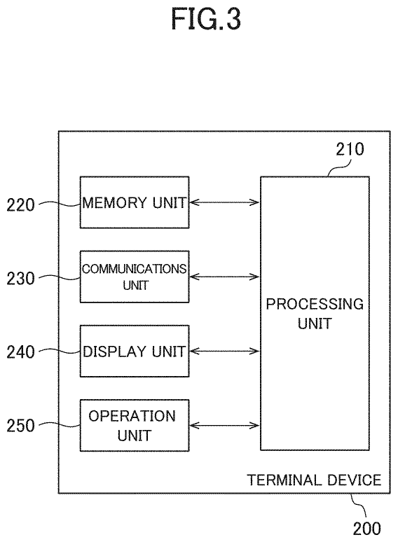

FIG. 1 shows an exemplary structure of a system including an information processing system 10 in accordance with the present embodiment. The system in accordance with the present embodiment includes a server system 100 and a terminal device 200. The structure of the system including the information processing system 10 is not necessarily limited to the one shown in FIG. 1 and may be modified in various manners, for example, by omitting some parts of the structure or by including an additional structure. For instance, FIG. 1 shows two terminal devices 200-1 and 200-2 as the terminal device 200. Alternatively, there may be provided only one terminal device 200 or three or more terminal devices 200. The same description applies to FIG. 2 and FIG. 3 (detailed below) regarding variations including the omission of parts of the structure and the inclusion of an additional structure.

The information processing system 10 in accordance with the present embodiment is an equivalent of, for example, the server system 100. The technique in accordance with the present embodiment is however not necessarily limited to this example. The functions of the information processing system 10 may be provided by a distributed system that includes the server system 100 and other apparatus. For instance, the information processing system 10 in accordance with the present embodiment may be implemented by distributed processing between the server system 100 and the terminal device 200. The following will focus on examples where the information processing system 10 is the server system 100.

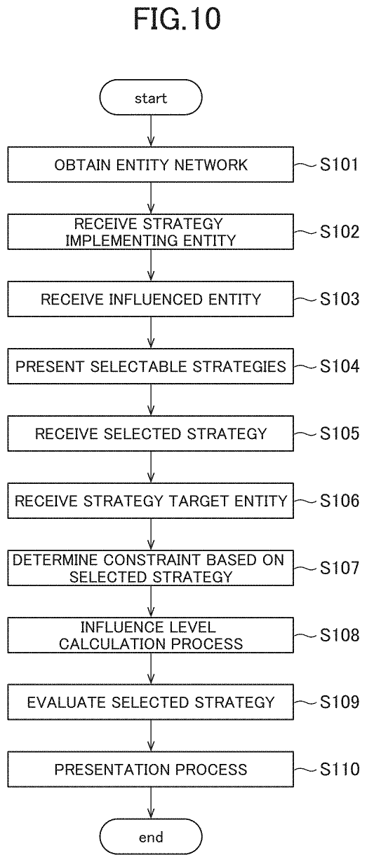

The server system 100 may include a single server or a plurality of servers. For instance, the server system 100 may include a database server and an application server. The database server contains entity networks (which will be described later) and other various data. The application server performs processes that will be described later with reference to, for example, FIG. 10. The plurality of servers may be physical servers or virtual servers. When a virtual server is used, the virtual server may be provided by a single physical server or by a plurality of physical servers in a distributed manner. The specific structure of the server system 100 has many variations in the present embodiment as described here.

The terminal device 200 is used by a user of the information processing system 10. The terminal device 200 may be a PC (personal computer), a mobile terminal such as a smartphone, or any other like apparatus.

The server system 100 is connected to the terminal device 200-1 and the terminal device 200-2, for example, over a network. The terminal device 200-1 and the terminal device 200-2 will be simply referred to as the terminal device 200 throughout the following description when there is no need to distinguish between multiple terminal devices. The network in this context is, for example, a public communications network such as the Internet and may be, for example, a LAN (local area network).

The information processing system 10 in accordance with the present embodiment is an OSINT (open source intelligence) system, for example, for collecting and analyzing data related to a target by using, for example, public information. The public information in this context includes various information that is legally available and widely accessible, such as securities reports, inter-industry relations tables, governments' official announcements, news reports on countries and businesses, and supply chain databases.

The server system 100 generates nodes with various attributes on the basis of public information. Each node represents a given entity and may in this context be a person, a business, or a country. Attributes are the various information determined on the basis of public information and include the entity's name, nationality, business field, sales, number of employees, shareholders and their capital contribution ratios, board members, customers and products. The name may be, for example, that of a country, business, person, or any organization.

When a given node has an attribute associated with another node, the two nodes are linked together by a directional edge. As an example, when a given entity has a shareholder that is another entity, the two nodes representing the respective entities are linked together by an edge representing an investment relationship. An edge in this context has directionality from an entity that gives influence to an entity that gets influenced. The edge has, for example, directionality from an entity that makes investment to an entity that gets the investment.

According to the technique in accordance with the present embodiment, the server system 100 obtains an entity network composed of a plurality of nodes, each representing an entity, that are linked by attribute-based directional edges. In other words, the entity network is a directed graph. The server system 100 performs analysis based on the entity network and implements a process of presenting results of the analysis. For instance, the terminal device 200 is used by a user of a service provided by the OSINT system. For instance, the user requests the server system 100 (information processing system 10) to perform some analysis by using the terminal device 200. The server system 100 performs analysis based on the entity network and feeds the results of the analysis to the terminal device 200.

FIG. 2 is a detailed block diagram of an exemplary structure of the server system 100. The server system 100 includes, for example, a processing unit 110, a memory unit 120, and a communications unit 130.

The processing unit 110 in accordance with the present embodiment includes the following hardware. The hardware may include either one or both of a digital signal processing circuit and an analog signal processing circuit. For instance, the hardware may include one or more circuit elements or devices mounted on a circuit board. Each circuit device is, for example, an IC (integrated circuit) chip or an FPGA (field-programmable gate array). Each circuit element is, for example, a resistor or a capacitor.

The processing unit 110 may be provided by the processor described below. The server system 100 in accordance with the present embodiment includes an information-containing memory and a processor that operates on the basis of the information stored in the memory. The information is, for example, programs and various data. The processor includes hardware. The processor may be any processor including a CPU (central processing unit), a GPU (graphics processing unit), and a DSP (digital signal processor). The memory may be, for example, a semiconductor memory such as a SRAM (static random access memory), a DRAM (dynamic random access memory), or a flash memory; a register; a magnetic storage device such as a hard disk drive (HDD); or an optical storage device such as an optical disc drive. For instance, the memory contains computer-readable instructions, so that the processor can execute the instructions to provide the functions of the processing unit 110. These instructions may be a set of instructions contained in a program or instructions for instructing the processor hardware circuit to operate.

The processing unit 110 includes, for example, an entity network obtaining unit 111, an influence level calculation unit 112, a strategy determining unit 113, a strategy interpretation unit 114, an evaluation processing unit 115, and a presentation processing unit 116.

The entity network obtaining unit 111 obtains an entity network 121. For instance, the entity network obtaining unit 111 may generate the entity network 121 on the basis of public information. The entity network obtaining unit 111 stores the obtained entity network 121 in the memory unit 120. Alternatively, the entity network 121 may be generated by a system other than the information processing system 10 in accordance with the present embodiment, so that the entity network obtaining unit 111 can obtain a result of the entity network generation.

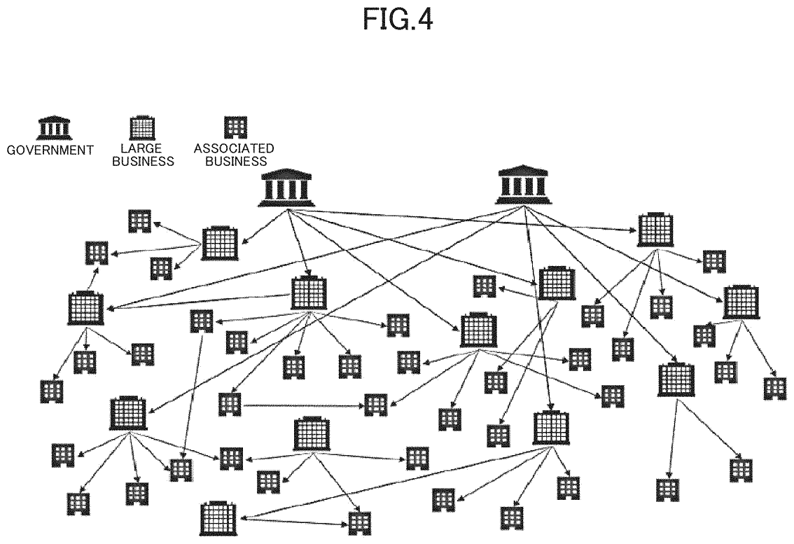

The entity network obtaining unit 111 may obtain, as the entity network 121, a network of interconnected nodes corresponding to respective entities including first and second entities on the basis of investment relationships as will be described later with reference to, for example, FIG. 4. The first entity is a strategy implementing entity (detailed later). The second entity is, for example, an influenced entity (detailed later).

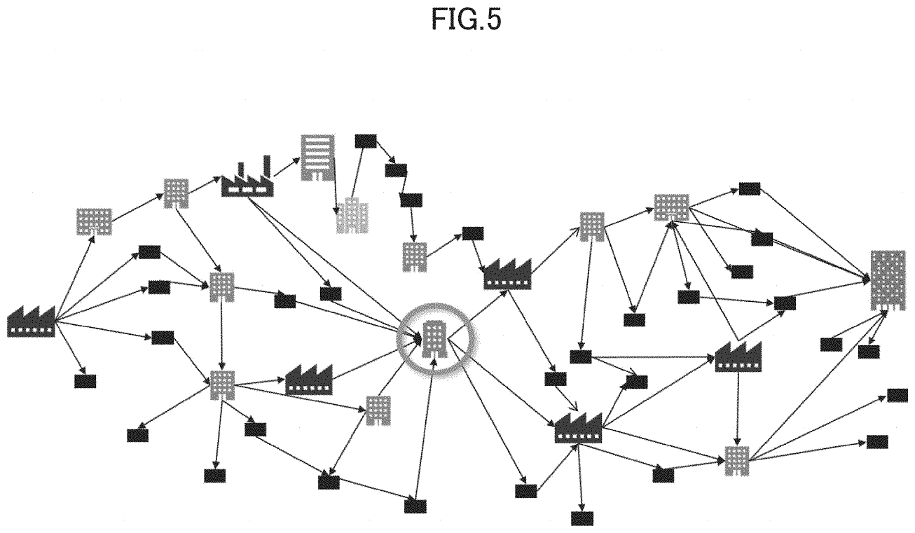

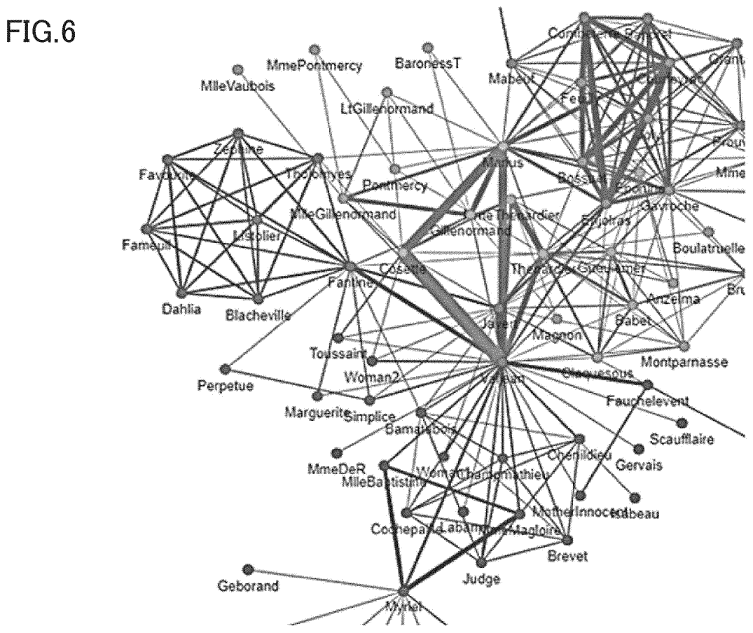

The entity network obtaining unit 111 may alternatively obtain, as the entity network 121, a network representing a supply chain (detailed later with reference to FIG. 5) or a network representing interpersonal correlation (detailed later with reference to FIG. 6). The entity network obtaining unit 111 may obtain each of the networks detailed later with reference to FIGS. 4 to 6, by obtaining the entity network 121 including various relationships such as investment relationships, supply chains, and interpersonal correlation and extracting a part of the entity network 121.

The influence level calculation unit 112 implements an influence level calculation process of calculating the influence level of a given entity on another entity on the basis of the entity network 121. For instance, when the entity network 121 represents investment relationships, the influence level is the NPI (network power index) disclosed in Japanese Unexamined Patent Application Publication, JP2021-005298A. The influence level calculation unit 112 calculates the influence level on at least the influenced entity (second entity) on the basis of the entity network 121.

The strategy determining unit 113 presents a plurality of strategies and receives a selection from the presented strategies. A strategy represents a future action taken by the strategy implementing entity (first entity). The strategy implementing entity may be a business or a country. The strategy determined by the strategy determining unit 113 may alternatively be referred to as the selected strategy in the following description.

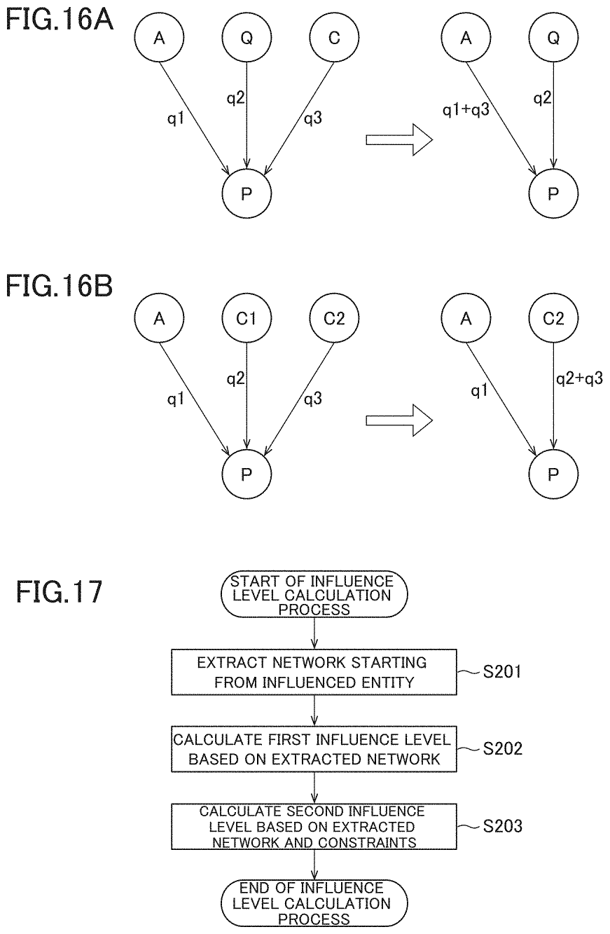

The strategy interpretation unit 114 implements a process of interpreting the determined strategy. Specifically, the strategy interpretation unit 114 implements a process of determining a constraint in an influence level calculation process on the basis of the strategy selected by the user. Specific examples will be given later with reference to FIGS. 15A to 16B. The influence level calculation unit 112 described above calculates a first influence level that is an influence level under no constraints and a second influence level that is an influence level under a constraint.

The evaluation processing unit 115 evaluates the selected strategy on the basis of a result of the influence level calculation process. Specifically, the evaluation processing unit 115 evaluates the selected strategy on the basis of a comparison between the first influence level and the second influence level.

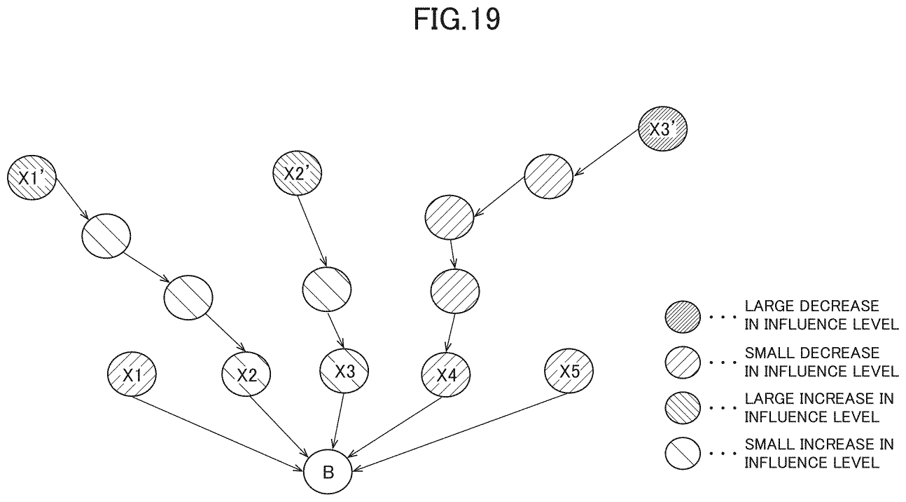

The presentation processing unit 116 implements a process of presenting the evaluation result obtained by the evaluation processing unit 115 to the user. The presentation processing unit 116 implements a process of displaying the display screen detailed later with reference to, for example, FIGS. 19, 21, and 22.

The memory unit 120 is a working area for the processing unit 110 and contains various information. The memory unit 120 may be any memory device including a semiconductor memory such as an SRAM, a DRAM, a ROM, and a flash memory; a register; a magnetic storage device such as a hard disk drive; and an optical storage device such as an optical disc drive.

The memory unit 120 contains, for example, the entity network 121 obtained by the entity network obtaining unit 111. The memory unit 120 may contain public information such as a securities report or an inter-industry relations table. The memory unit 120 may additionally contain any information on processes in accordance with the present embodiment.

The communications unit 130 is an interface for performing communications over a network and includes, for example, an antenna, an RF (radio frequency) circuit, and a baseband circuit. The communications unit 130 may operate under the control of the processing unit 110 and may include a communications controlling processor other than the processing unit 110. The communications unit 130 is an interface for performing communications in accordance with, for example, the TCP/IP (transmission control protocol/internet protocol). The specific communications scheme however has many variations.

FIG. 3 is a detailed block diagram of an exemplary structure of the terminal device 200. The terminal device 200 includes, for example, a processing unit 210, a memory unit 220, a communications unit 230, a display unit 240, and an operation unit 250.

The processing unit 210 is hardware including either one or both of a digital signal processing circuit and an analog signal processing circuit. The processing unit 210 may be provided by a processor. This processor may be any processor including a CPU, a GPU, and a DSP. The processor executes the instructions stored in the memory of the terminal device 200 to provide the functions of the processing unit 210.

The memory unit 220 is a working area for the processing unit 210 and provided by any memory such as an SRAM, a DRAM, or a ROM.

The communications unit 230 is an interface for performing communications over a network and includes, for example, an antenna, an RF circuit, and a baseband circuit. The communications unit 230 communicates with the server system 100 over, for example, a network.

The display unit 240 is an interface for displaying various information and may be a liquid crystal display device, an OLED display device, or a display device that operates under any other scheme. The operation unit 250 is an interface for receiving user operations. The operation unit 250 may be, for example, a button on the terminal device 200. The display unit 240 and the operation unit 250 may be combined to form a touch panel.

### 1.2 Specific Examples of Service

A description will be given next of specific examples of the service provided by the information processing system 10 (OSINT system). Four specific examples of the service will be described below, including business ownership stake network analysis, supply chain analysis, people network analysis, and SNS (social networking service) and news analysis.

FIG. 4 is a diagram of business ownership stake network analysis and shows an exemplary entity network representing investment relationships. A network is formed that represents investment relationships between, for example, countries and businesses on the basis of the information representative of the shareholders and their capital contribution ratios found in public information as shown in FIG. 4.

The information processing system 10 may analyze the influence level that a country and business has on another business. The influence level in this context indicates controlling power exercised through investment. The influence level may be the Shapley-Shubik index or the NPI, which is a generalization of the Shapley-Shubik index applied to networks.

For instance, it is possible to approximately learn what controlling power a particular country has on the supply of products in a given industry sector, by finding the influence level that the country has on businesses in that industry sector. It is, for example, possible to evaluate the influence of a critical domestic incident on the stable supply of a product. The information processing system 10 may find the influential power that individual countries have on global businesses. In this manner, it is possible to learn the power balance between countries. It is also possible to learn about how the power balance is changing, by finding temporal changes of the influential power that individual countries have on global businesses.

Alternatively, the information processing system 10 may find the influential power that a country has on a business related to infrastructure in a given country. The infrastructure-related business may be a business related to electric power or another form of energy or a business that provides a mobile communications network. In this manner, it becomes possible to evaluate the risk of the infrastructure stopping functioning. The information processing system 10 may alternatively find the influential power on a business that owns technology that can be diverted to military use. In this manner, it becomes possible to detect security risk.

The information processing system 10 may find changes that may occur in the influence level of a country or business when they take a particular course of action. As an example, in the wake of a shift in the foreign policy of a given country, it is possible to simulate the influence of the new foreign policy on other countries, by calculating the influence level before and after the shift.

It also becomes possible to analyze complex investment relationships, which humans would find hard to detect, through business ownership stake network analysis.

FIG. 5 shows a specific example of the entity network 121 representing a supply chain. For instance, each node of the entity network 121 represents, for example, a business engaged in a commercial activity such as the procurement of raw material, manufacture, delivery, sale, and consumption.

The information processing system 10 in accordance with the present embodiment may, for example, implement a process of detecting a choke point in a supply chain. A choke point is such a node on a path linking two nodes or communities that if the node is not there, the link between the two nodes is cut or only available when following a path with a length several times that of the original path. The community in this context is a set of closely linked nodes.

Securing supply chains is an essential issue to countries and businesses. For instance, if there is a choke point in a semiconductor supply chain, one can exert a strong influential power on the entire semiconductor industry by controlling the entity corresponding to that choke point. The information processing system 10 is capable of presenting an important entity that may exist in a target industry by discovering a choke point.

The information processing system 10 may analyze an influence level on the entity represented by a choke point. In this manner, it becomes possible to identify a country or business that has a strong influential power on a particular industry. The information processing system 10 may present what strategy a particular country or business should employ to increase the influence level thereof on the entity represented by a choke point.

The information processing system 10 may, in a supply chain analysis, implement a process of checking that an entity has no relationships with a business that is prohibited from trading. For instance, if there is a mine that has forced labor issues, it is important for every business to not incorporate the products of the mine into their supply chain of products. The information processing system 10 may, for example, implement a process of searching for a bridge business that mediates between a community centered around a business that is prohibited from trading and a community in which a client business (service user) is involved. The information processing system 10 can restrain the supply chain of the client business from being contaminated, by proposing that the client business discontinue relationships with the bridge business. The information processing system 10 may implement a process of searching for and presenting businesses that resemble the bridge business. By proposing that the client business have no relationships with businesses that resemble the bridge business, it is possible to further restrain the contamination of the supply chain of the client business. The similarity to the bridge business of a business not found in the supply chain database can be calculated by using, for example, their attributes. It is therefore possible to readily generate a black list covering businesses that have no commercial relationships.

The information processing system 10 may find changes that may occur in the supply chain of a country or business when they take a particular course of action. As an example, in the wake of a shift in the policy of a given country, it is possible to simulate the influence of the new policy on a supply chain, by comparing the supply chain prior to the policy shift with the supply chain subsequent to the policy shift.

FIG. 6 shows a specific example of the entity network 121 (people network). Each node in FIG. 6 corresponds to an entity representing a person. For instance, the information processing system 10 generates a people network on the basis of, for example, information such as the countries and organizations to which the people belong and information indicating connections, for example, over SNS's.

For instance, the information processing system 10 may perform analysis using a people network that includes nodes representing researchers in a given research field. For instance, the information processing system 10 identifies a community of closely linked nodes on a people network. The community in this context may be a set of researchers who belong to the same country or a set of researchers who belong to the same research organization or business. For instance, the information processing system 10 implements a process of identifying a key person who mediates between a given community and another community. As an example, the government of a given country can promote international research activities by identifying a key person who mediates between a community in that country and a community in a friendly country. As another example, the government can restrain illegal leaking of research results by identifying a key person who mediates between a community in the country and a community in a hostile country.

People networks are not necessarily limited to those with nodes that only correspond to people and may include nodes that correspond to businesses. For instance, the information processing system 10 generates a people network representing connections between people and businesses and performs analysis on politically important people and economically important people. For instance, the information processing system 10 may evaluate the influence of an economic sanction by a given country on important people in the government. The information processing system 10 may analyze the association between important people in the government and economy and the association with businesses through investment and if a policy has led to a change in the influential power on businesses, predict how the people network would be influenced. The information processing system 10 may identify the person who connects unfavorable communities.

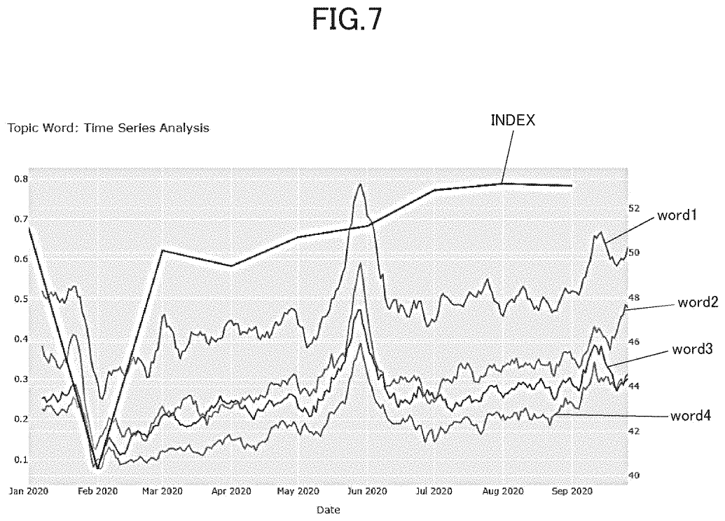

FIG. 7 is a diagram of SNS and news analysis. In FIG. 7, “word 1” to “word 4” respectively denote a temporal change of the occurrence count or occurrence frequency of a given word in the SNS's and news sources. The index in FIG. 7 represents temporal changes of a political or economic index. The index in this context may be an approval rating of a particular politician or political party or an economic index such as the PMI (purchasing managers' index).

The information processing system 10 implements a process of analyzing the words that appear on the SNS's and news sources to identify words correlated to a given index. FIG. 7 shows an example where the four words, word 1 to word 4, have been identified as the words highly correlated to the index. In such an example, the index increases with an increase in the occurrence frequency of the words corresponding to word 1 to word 4 and decreases with a decrease in the occurrence frequency. It therefore becomes possible to, for example, predict changes in the index on the basis of the occurrence frequency of words used in, for example, the SNS's.

Specifically, the information processing system 10 may perform topic analysis on, for example, SNS's. Topic analysis is performed, for example, in accordance with a topic model. Assume, as an example, that a given document includes some potential topics and that words are generated in accordance with a probability that is unique to each topic. A topic model is a model for calculating a statistically optimal number of topics and an optimal probability distribution of words occurring under each topic on such an assumption. The information processing system 10 may find a correlation between the changing topics and the changes in another index, by monitoring changes in the proportions of the topics. For instance, the information processing system 10 may analyze the relevance between topics on the Twitter® and the approval ratings of politicians and political parties. In this manner, it becomes possible to predict variations of the approval ratings on the basis of the changing topics.

The information processing system 10 may perform emotion analysis. The information processing system 10 categorizes the contents of the comments on SNS posts and newspaper articles into, for example, 3 types: positive, negative, and neutral. The information processing system 10 is capable of, for example, learning about or predicting changes in public opinions, by monitoring changes in the proportions. As an example, the information processing system 10 may analyze public opinions on important topics, by combining the topic analysis and emotion analysis described above.

Countries, businesses, and important people form networks that are ever more global and complex than humans can analyze manually. In contrast, the OSINT system described above is capable of the analysis of, for example, networks representing business controls through investment, supply chains, and people networks of important people. Since the OSINT system is capable of deciphering complex relationships and learning about the public opinions that may influence policy decision-making, the government and businesses can, for example, devise an optimal strategy.

### 2. Details of Processes

The following will describe processes in detail in accordance with the present embodiment. A technique in accordance with the present embodiment, in the narrow sense of the term, refers to business ownership stake network analysis and is a technique that assists the government, businesses, and other entities in devising a strategy.

### 2.1 Calculation of Influence Level

A description is given first of a process of calculating an influence level representing the influence of a given entity on another entity. The influence level in accordance with the present embodiment is the Shapley-Shubik index or the NPI, which is a generalization of the Shapley-Shubik index, and may be calculated by, for example, the technique disclosed in Japanese Unexamined Patent Application Publication, JP2021-005298A.

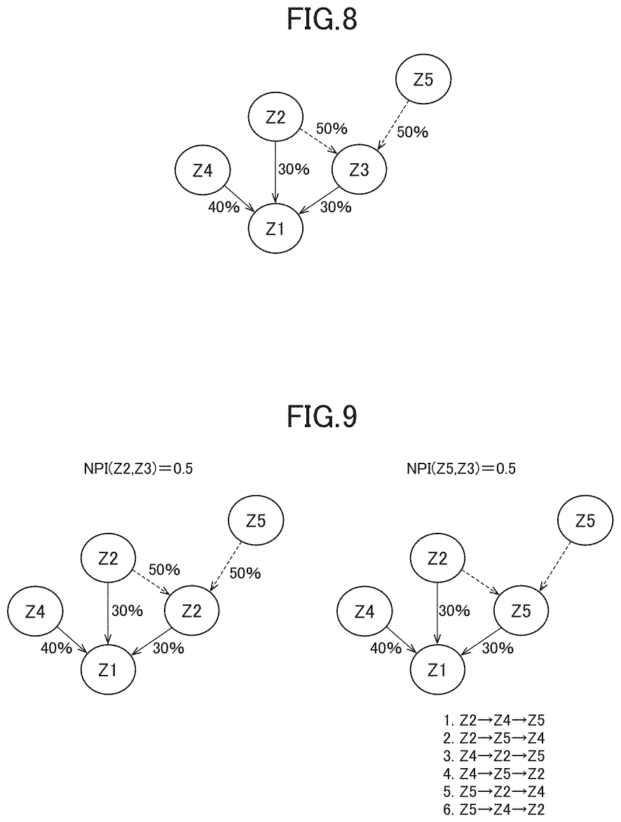

FIG. 8 shows an example of the entity network 121 representing the relationships of shareholders. In the example shown in FIG. 8, entity Z2 and entity Z3 each own 30% of the total shares of entity Z1, and entity Z4 has 40% of the shares. Entity Z2 and entity Z5 each own 50% of the total shares of entity Z3.

The Shapley-Shubik index is calculated through the ratio of the numbers of cases of a particular shareholder being the “first voter who determines the voting result” in his/her turn of voting when two or more shareholders attempt to collaborate to win a ballot. The “first voter who determines the voting result” will be referred to as the pivotal voter throughout the following description. In other words, the Shapley-Shubik index indicates the probability of a company holding a casting vote that affects the voting result.

For instance, there are two entities, entity Z2 and entity Z5, that own shares in entity Z3. Therefore, a vote is cast either first by Z2 and then by Z5 or first by Z5 and then by Z2. Because entities Z2 and Z5 have am equal capital contribution ratio of 50%, the pivotal voter is entity Z5 when a vote is cast first by Z2 and then by Z5 and is entity Z2 when a vote is cast first by Z5 and then by Z2. In other words, entity Z2 has a 0.5 probability of being the pivotal voter, and entity Z5 has a 0.5 probability of being the pivotal voter, for entity Z3. Letting the influence level of entity X on entity Y be represented by the NPI of NPI(X,Y), it follows that NPI(Z2, Z3)=0.5 and also that NPI(Z5, Z3)=0.5.

Similar procedures are followed when the Shapley-Shubik index representing the influence on entity Z1 is calculated. Voting orders of the shareholders who directly own the shares of entity Z1 are assumed, and the pivotal voter is determined in each voting order. For instance, because there are three entities, entity Z2, entity Z3, and entity Z4, that own the shares of entity Z1, the pivotal voter is determined for each of the six voting orders. Note however that the Shapley-Shubik index is applied to a network for the NPI, so that the influence of a business that does not directly own shares is taken into account. For instance, in the example shown in FIG. 8, entity Z3 is controlled by entity Z2 at a 0.5 probability and by entity Z5 at a 0.5 probability as described above. This is equivalent to the label of the node representing entity Z3 being changed to entity Z2 at a 0.5 probability and to entity Z5 at a 0.5 probability.

FIG. 9 is a diagram of a process of calculating an influence level on entity Z1 on the basis of the network in which the label of the node representing entity Z3 has been changed. If the label corresponding to entity Z3 is changed to entity Z2, it follows that entity Z2 and entity Z4 have 60% and 40% respectively of the total shares of entity Z1. Therefore, there are two possible voting orders (Z2 voting before Z4 and Z4 voting before Z2), and entity Z2 is the pivotal voter in either voting order.

If the label corresponding to entity Z3 is changed to entity Z5, it follows that entity Z2, entity Z5, and entity Z4 have 30%, 30%, and 40% respectively of the total shares of entity Z1. Therefore, there are six possible voting orders as shown in FIG. 9, and the entity that is the second voter becomes the pivotal voter in any of these voting orders. In other words, entity Z2, entity Z4, and entity Z5 equally have a 1/3 probability of being the pivotal voter.

With all these factored in, NPI, which represents the influence level on entity Z1, is given by a set of equations (1) below.

NPI(Z2,Z1)=NPI(Z2,Z3)×1+NPI(Z5,Z3)×1/3=2/3

NPI(Z4,Z1)=NPI(Z5,Z3)×1/3=1/6

NPI(Z5,Z1)=NPI(Z5,Z3)×1/3=1/6 (1)

The NPI has been calculated above by taking all voting orders into account because a simple network is assumed. Alternatively, a voting order may be determined using random numbers, and calculation may be done in accordance with this voting order, as disclosed in however Japanese Unexamined Patent Application Publication, JP2021-005298A. As an example, JP2021-005298A performs an updated label identifying process of calculating a pivotal voter sequentially from a starting node toward an upper-level node and updating the label of each node in accordance with results of the calculation. A single unit of processing is completed by performing this updated label identifying process on all nodes that have an upper-level node. JP2021-005298A calculates the NPI, which represents the influence level on a node, by repeating the single unit of processing a prescribed number of times while changing the voting order using random numbers to identify the proportions of the labels given to the nodes.

No further description is given here on the calculation of the influence level because the Shapley-Shubik index and NPI are publicly known. In the present embodiment, the influence level is not necessarily calculated by this technique, and the Shapley-Shubik index, the NPI, or any other technique that uses extended information as an influence level may be used.

### 2.2 Flow of Process

FIG. 10 is a flow chart representing a process flow in accordance with the present embodiment. Each step is described below in detail.

### Step S101: Obtaining an Entity Network

First of all, in step S101, the entity network obtaining unit 111 obtains the entity network 121 representing investment relationships between countries and businesses. The entity network obtaining unit 111 may generate the entity network 121 on the basis of public information such as securities reports or may obtain the entity network 121 that is already generated.

### Step S102: Receiving Strategy Implementing Entity

The strategy determining unit 113, in step S102, receives a strategy implementing entity as an input. The strategy implementing entity is an entity that implements a strategy. A strategy indicates future actions of an entity, for example, actions that change the relationships thereof with other entities. When the entity is a country, the strategy may be its national strategies such as its foreign or economic policies. When the entity is a business, the strategy may be, for example, a management strategy.

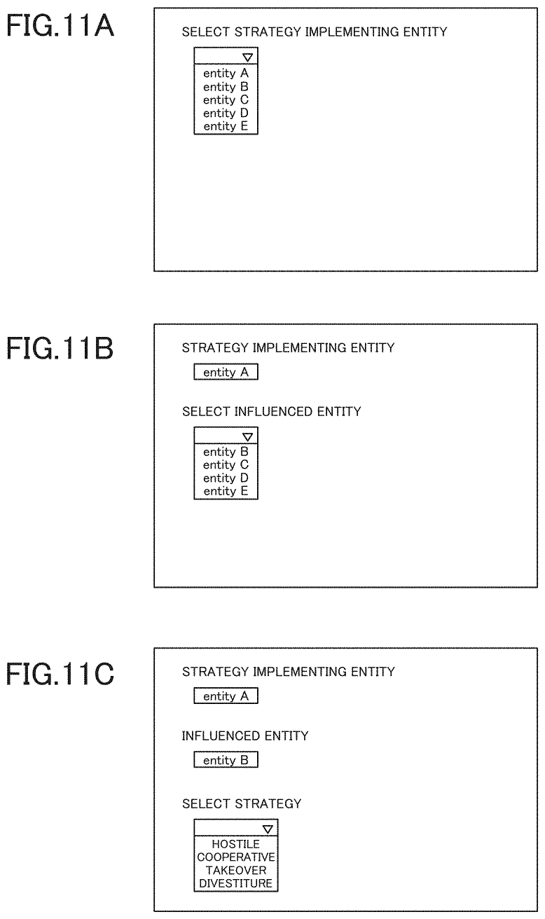

FIG. 11A shows an exemplary display screen for a user selection input of a strategy implementing entity. The screen shown in FIG. 11A is displayed, for example, by the display unit 240 of the terminal device 200. For instance, the strategy determining unit 113 of the server system 100 may generate screen information corresponding to the screen shown in FIG. 11A and transmit the screen information to the terminal device 200 via the communications unit 130. The screen information in this context may represent the image per se or may be information for drawing an image. The display screen shown in FIG. 11A may be displayed by a display unit (not shown) of the server system 100 or by any other device. The same is true for the display screens in FIG. 11B and subsequent drawings in that various modifications can be made to the device on which the display screen is displayed.

Referring to FIG. 11A, the display screen has an area that allows an input of a strategy implementing entity. FIG. 11A shows an example where a pulldown menu is used. The specific selection technique may be however modified in various manners. For instance, the user may be allowed to freely input a strategy implementing entity by, for example, entering text. Alternatively, the terminal device 200 may display the entity network 121 on the display unit 240 and receive a node selection operation through the operation unit 250 such as a pointing device or a touch panel. The screen where the user can input a selection, as an example, may be modified in various manners in FIGS. 11B to 14 (detailed later) as well as in FIG. 11A.

### Step S103: Receiving Influenced Entity

In step S103, the strategy determining unit 113 receives an influenced entity as an input. The influenced entity is an entity that is influenced. For example, the influence level calculation unit 112 implements a process of calculating the influence level of other entities on at least the influenced entity. In the narrow sense of the term, the influenced entity is the entity that corresponds to the starting point (lowest-level node) of the network for which the NPI will be calculated. In the example shown in FIG. 8, the influenced entity corresponds to entity Z1.

FIG. 11B shows an exemplary display screen for receiving an operation of selecting an influenced entity. Referring to FIG. 11B, the display screen has an area that allows an input of an influenced entity. The network for which the NPI will be calculated can be identified by receiving an input of an influenced entity. For instance, the influence level calculation unit 112 extracts a network that includes the selected influenced entity as a starting point from the entity network 121 stored in the memory unit 120 as shown in step S201 in FIG. 17 (detailed later). The network that is at least a part of the entity network 121 and that has an influenced entity as a starting point will be referred to as the extracted network throughout the following description. The process of identifying an extracted network will be described later.

It is assumed in this example that the strategy implemented by a strategy implementing entity is evaluated on the basis of the influence level thereof on an influenced entity. The strategy implementing entity therefore needs to be capable of influencing the influenced entity. In other words, the node corresponding to the strategy implementing entity is an upper-level one of the nodes that have a path between the nodes and the node representing the influenced entity. In this example, when the entity corresponding to a first node influences the entity corresponding to a second node, the first node will be referred to as an upper-level node for the second node. When one can start from an influenced entity and proceed via successive upper-level nodes to reach a strategy implementing entity, the strategy implementing entity is an upper-level node of the influenced entity.

The strategy determining unit 113 may therefore implement a process of extracting a candidate node for the influenced entity from the entity network 121 stored in the memory unit 120. For instance, the strategy determining unit 113 may start from the node corresponding to the strategy implementing entity and extract successive lower-level nodes to present the entities corresponding to the extracted nodes as candidates for the influenced entity in FIG. 11B. Alternatively, when any one of the entities is selected as the influenced entity in FIG. 11B, the strategy determining unit 113 may determine whether or not there exists a path linking the strategy entity to the influenced entity. If there exists no such a path, the strategy determining unit 113 may display an error message that notifies that the influenced entity is unsuitable.

### Step S104: Presenting a Strategy

The strategy determining unit 113, in step S104, implements a process of presenting a plurality of selectable strategies. FIG. 11C shows an exemplary display screen for presenting a strategy. Referring to FIG. 11C, the display screen displays a plurality of strategies and has an area where any of the strategies can be selected.

Of the entities in the entity network 121, the entity on which the strategy implementing entity (first entity) take actions will be referred to as the strategy target entity (third entity) throughout the following description. Referring to FIG. 11C, the selectable strategies include at least either a cooperative strategy in which the first entity cooperates with the third entity and a hostile strategy in which the first entity confronts the third entity. In this manner, it becomes possible to evaluate the influence that the cooperation and confrontation between entities have on the entity network 121. A hostile strategy is, for example, such a strategy that the entity always takes different actions from the other entity in a ballot. A cooperative strategy is, for example, such a strategy that the entity always takes the same actions as the other entity in a ballot.

The selectable strategies may further include a takeover strategy in which the first entity takes over the third entity and a divestiture strategy in which the first entity divests the third entity, as shown in FIG. 11C. In this manner, it becomes possible to evaluate the influence that the divestiture and takeover of an entity have on the entity network 121.

### Step S105: Receiving Selected Strategy

In step S105, the strategy determining unit 113 receives a user input of a selection from the presented strategies. In the example shown in FIG. 11C, the selected strategy may be any one of a hostile strategy, a cooperative strategy, a divestiture strategy, and a takeover strategy.

### Step S106: Receiving Strategy Target Entity

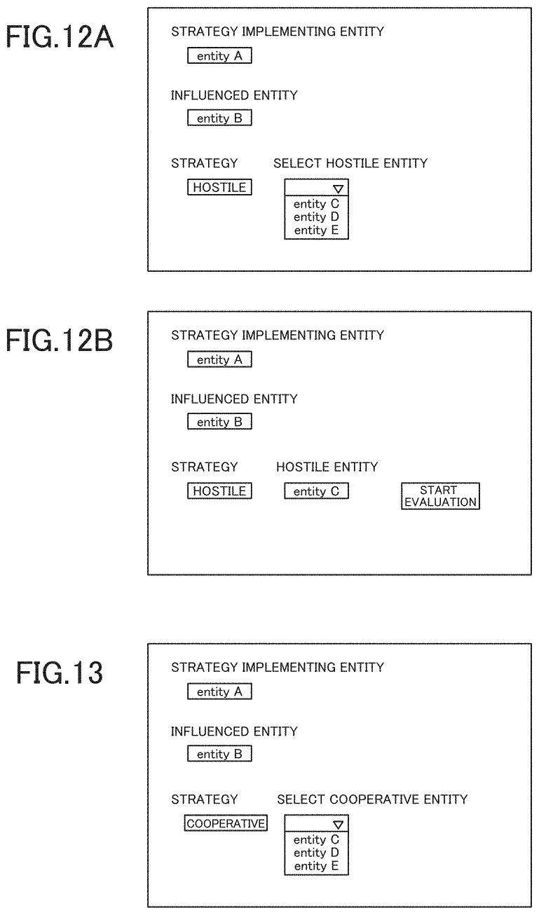

The strategy determining unit 113, in step S106, implements a process of receiving a selected strategy target entity. FIG. 12A shows an exemplary display screen for receiving an operation of selecting a strategy target entity when the hostile strategy has been selected as the strategy to be pursued. Referring to FIG. 12A, the display screen has an area that allows an input of a confronting entity.

The strategy target entity may be selected from all the entities in the entity network 121. Alternatively, the strategy determining unit 113 may implement a process of extracting candidates for the strategy target entity to present the extracted candidates. For instance, in this example, an influenced entity is selected, and the influence level on at least the influenced entity is evaluated. Therefore, when the strategy target entity has no path to the influenced entity, the influence level does not change, and the strategy is not well worth evaluating, even if the strategy is implemented. The strategy determining unit 113 may therefore present the entities that correspond to the upper-level nodes that have a path to the influenced entity in the entity network 121 as candidates for the strategy target entity. For instance, the influence level calculation unit 112 may perform an extraction process for an extracted network (detailed later) by using step S201 shown in FIG. 17 between step S102 and step S106. The strategy determining unit 113 then presents the entities corresponding to the nodes included in the extracted network as candidates for the strategy target entity.

FIG. 12B shows an exemplary display screen when a strategy target entity has been selected. In the example shown in FIG. 12B, the user requests the information processing system 10 to evaluate the hostile strategy in which entity A confronts entity C, on the basis of the influence level on entity B. This particular configuration identifies the information necessary for processing, so that, for example, an evaluation button can be displayed on the display screen. When the user selects the button, step S107 and subsequent steps in FIG. 10 are started.

When the selected strategy is not a hostile strategy, step S106 is performed in a similar manner. For instance, FIG. 13 shows an exemplary display screen for receiving an operation of selecting a strategy target entity when the cooperative strategy has been selected as the strategy to be pursued. Referring to FIG. 13, the display screen has an area that allows an input of a cooperative entity. The strategy determining unit 113 may implement a process of extracting candidates for the strategy target entity similarly to the extraction of candidates for the hostile strategy.

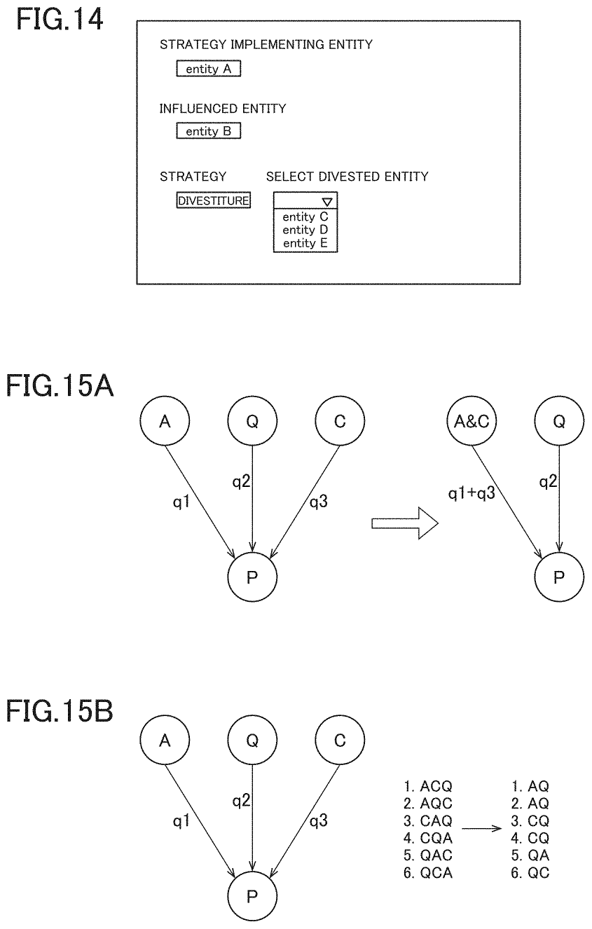

FIG. 14 shows an exemplary display screen for receiving an operation of selecting a strategy target entity when the divestiture strategy has been selected as the strategy to be pursued. Referring to FIG. 14, the display screen has an area that allows an input of a divested entity. If the strategy target entity is not owned by the strategy implementing entity in a divestiture strategy, the strategy cannot be implemented in the first place. The strategy determining unit 113 may therefore implement a process of extracting and presenting the entities owned by the strategy implementing entity as candidates for the strategy implementing entity.

In a divestiture strategy, the investment relationships between entities can change depending on the entity that purchases the divested entity. Accordingly, the strategy determining unit 113 may display a screen that has an area that allows an input of the entity that purchases the divested entity (not shown in FIG. 14).

In response to a takeover strategy having been selected as the strategy to be pursued, the strategy determining unit 113 implements a process of displaying a display screen on which an operation is received of selecting a strategy target entity representing an entity that is taken over and receiving a selection made by the user. No further details or related drawings are given here.

### Step S107: Interpreting Strategy

The strategy interpretation unit 114, in step S107, implements a process of interpreting the strategy received in step S105 shown in FIG. 10. Specifically, the strategy interpretation unit 114 implements a process of finding constraints on the calculation of an influence level on the basis of the strategy. A constraint is information with which the process of identifying the pivotal voter is changed in the Shapley-Shubik index and NPI.

Let Q1, . . . Qk represent a set of shareholders of entity P and each shareholder have a shareholding ratio (q1, . . . , qk) of all shares, where k is an integer greater than or equal to 2. The calculation of the influence level includes the process of identifying the pivotal voter for a given sequence Q1′ to Qk′ of Q1 to Qk as described earlier with reference to FIGS. 8 and 9.

In this example, the strategy implementing entity is entity A, the influenced entity is entity B. and the strategy target entity is entity C. When there are two or more strategy target entities like the divested entity and the purchasing entity in a divestiture strategy, the strategy target entities will be referred to as entity C1, entity C2, and so on.

In a cooperative strategy in which entity A cooperates with entity C, the following constraints are additionally imposed on the process of identifying a pivotal voter.

Cooperative Constraint 1: If only entity A matches certain Qs, Qs is rewritten as A&C, and the shareholding ratio thereof is set to qs, where s is an integer greater than or equal 1 and less than or equal to k.

Cooperative Constraint 2: If only entity C matches certain Qt, Qt is rewritten as A&C. and the shareholding ratio thereof is set to qt, where t is an integer greater than or equal 1 and less than or equal to k.

Cooperative Constraint 3: If entity A and entity C match Qs and Qt respectively, Qs and Qt are deleted, A&C is inserted, and the shareholding ratio of A&C is set to qs+qt.

In a constraint, entity A may be a node that represents another entity and the label of which has been replaced by entity A. The same description applies to entity C in a constraint.

As described in the foregoing, in a cooperative strategy, the node corresponding to entity A and the node corresponding to entity C are replaced by the node corresponding to entity A&C. Since entity A and entity C cast a vote in a completely cooperative manner in a ballot over a given issue in a cooperative strategy, entity A and entity C can be considered entity A&C, which is a single entity that owns the shares of entity A and entity C.

Therefore, entity A&C can be interpreted as having a shareholding ratio corresponding to that of entity A when the shareholder of given entity P includes only A as described in Cooperative Constraint 1 above. Likewise, entity A&C can be interpreted as having a shareholding ratio corresponding to that of entity C when the shareholder of given entity P includes only C as described in Cooperative Constraint 2. Entity A&C can be interpreted as having a shareholding ratio that is equal to the sum of the shareholding ratio of entity A and the shareholding ratio of entity C when the shareholder of given entity P includes both A and C as described in Cooperative Constraint 3.

FIG. 15A is a diagram of, as an example, a constraint that is a result of interpretation of a cooperative strategy, showing a specific example under Cooperative Constraint 3 given above. FIG. 15A shows an example of two immediate hierarchical levels in an extracted network. Entity P in FIG. 15A may be entity B, which is an influenced entity, or may be an upper level entity of entity B. This description also applies to FIGS. 15B to 16B.

In FIG. 15A, P has three shareholders, A, Q, and C with respective shareholding ratios of q1, q2, and q3. Since entity P's shareholders include entity A, which is the strategy implementing entity, and entity C, which is the strategy target entity, the nodes that correspond to A and C are deleted. A new node is added that corresponds to entity A&C. The shareholding ratio of entity A&C is set to q1+q3.

The influence level calculation unit 112 calculates the influence level of entity A&C as the influence level of entity A. For instance, the influence level calculation unit 112 calculates the value of NPI(A&C,P) and regards this value as the value of NPI(A.P). The influence level calculation unit 112 behaves in the same manner when the entity network 121 is highly complex. The influence level can be calculated with the cooperative strategy taken into account, by using the aforementioned constraints in each process of identifying a pivotal voter.

In a hostile strategy in which entity A confronts entity C, the following constraints are additionally imposed on the process of identifying a pivotal voter.

Hostile Constraint 1: If entity A appears before a pivotal voter is identified in the sequence Q1′ to Qn′, entity C is removed from this sequence.

Hostile Constraint 2: If entity C appears before a pivotal voter is identified in the sequence Q1′ to Qn′, entity A is removed from this sequence.

In the process of identifying a pivotal voter, the voter at which the accumulative shareholding ratio exceeds a threshold value for the first time is identified as the pivotal voter. This means that the voting by the pivotal voter makes the accumulative number of votes cast in favor of one of the choices available exceed a target value if the pivotal voter votes in the same manner as the voters who cast a vote before the pivotal voter. On the other hand, when entity A completely confronts entity C, entity A and entity C vote in different manners. For instance, when asked to express an agreement or disagreement to a given issue, one will agree, and the other will disagree. In an election of a representative person, entity A and entity C cast a vote in favor of different candidates. In other words, in a hostile strategy, there is absolutely no situation in which either one of entity A and entity C may cast a vote in a manner cooperative to the other so as to make the accumulative number of votes cast in favor of one of the choices available exceed a target value.

The influence level calculation unit 112 therefore implements a process of, when one entity appears, excluding the other entity from the sequence in the process of identifying a pivotal voter as stipulated in Hostile Constraint 1 and Hostile Constraint 2 described above. In this manner, it becomes possible to appropriately depict confrontation between entity A and entity C in the form of constraints.

FIG. 15B is a diagram of, as an example, a constraint that is a result of interpretation of a hostile strategy. In FIG. 15B, P has three shareholders, A. Q, and C with respective shareholding ratios of q1, q2, and q3. There are six possible sequences as shown in FIG. 15B. Because entity A appears before the others in sequence patterns 1, 2 and 5, entity C is excluded from this sequence. Similarly, because entity C appears before the others in sequence patterns 3, 4 and 6, entity A is excluded from this sequence.

In a takeover strategy in which entity A takes over entity C, the following constraints are additionally imposed on the process of identifying a pivotal voter.

Takeover Constraint 1: if only entity C matches certain Qs, the label of Qs is rewritten as entity A.

Takeover Constraint 2: If entity A and entity C match Qs and Qt respectively. Qt is deleted, and the shareholding ratio of Qs is set to qs+qt.

The label of the node corresponding to entity C is replaced by entity A in a takeover strategy as described here. If there exist two or more nodes with a label, “entity A,” as a result of the replacement, these nodes are aggregated. In this manner, it becomes possible to appropriately depict the takeover by entity A in the form of constraints.

FIG. 16A is a diagram of, as an example, a constraint that is a result of interpretation of a takeover strategy, showing a specific example under Takeover Constraint 2 given above. In FIG. 16A, assume that P has three shareholders A. Q, and C with respective shareholding ratios of q1, q2, and q3. Since entity P's shareholders include entity A, which is the strategy implementing entity, and entity C, which is the takeover target, the node corresponding to C is deleted. The shareholding ratio of entity A is set to q1+q3.

In a divestiture strategy in which entity A divests entity C1 to entity C2, the following constraints are additionally imposed on the process of identifying a pivotal voter.

Divestiture Constraint 1: If entity C1 matches certain Qs, Qs is rewritten as entity C2.

Divestiture Constraint 2: If entity C1 and entity C2 match Qs and Qt respectively, Qs is deleted, and the shareholding ratio of Qt is set to qs+qt.

The label of the node corresponding to entity C1 is replaced by entity C2 in a divestiture strategy as described in here. If there exist two or more nodes with a label, “entity C2,” as a result of the replacement, these nodes are aggregated. In this manner, it becomes possible to appropriately depict the divestiture of entity C1 to entity C2 in the form of constraints.

FIG. 16B is a diagram of, as an example, a constraint that is a result of interpretation of a divestiture strategy, showing a specific example under Divestiture Constraint 2 given above. In FIG. 16B, assume that X has three shareholders A. C1, and C2 with respective shareholding ratios of q1, q2, and q3. Since entity X's shareholders include entity C1, which is the divested entity, and entity C2, to which entity C1 is divested, the node corresponding to C1 is deleted. The shareholding ratio of entity C2 is set to q2+q3.

### Step S108: Calculating Influence Level

The steps up to step S106 have identified the strategy implementing entity, the influenced entity, the strategy, and the strategy target entity. Step S107 converts the strategy to constraints in an influence calculation process. Accordingly, in step S108, the influence level calculation unit 112 implements a process of calculating the influence level for use in a strategy evaluation.

FIG. 17 is a flow chart representing an influence level calculation process in step S108. First of all, in step S201, the influence level calculation unit 112 implements a process of extracting, as an extracted network, a network that includes the influenced entity as a starting point.

For instance, the influence level calculation unit 112, first of all, implements a process of identifying a node corresponding to the influenced entity and adding that node to the extracted network. Next, the influence level calculation unit 112 implements a node addition process of adding an upper-level node that is directly linked to the node to the extracted network. The influence level calculation unit 112 repeatedly implements this node addition process for each new node added to the extracted network. For instance, immediately after a node representing the influenced entity is added, a node representing a shareholder who directly invests in the influenced entity is added to the extracted network. In the next node addition process, a node representing a shareholder who owns shares in a shareholder of the influenced entity, that is, an entity that is two levels above the influenced entity, is added to the extracted network. The same description applies to the third and upper levels. The influence level calculation unit 112 repeats the node addition process until given finishing conditions are satisfied, to obtain the extracted network when the finishing conditions are satisfied. In this manner, it becomes possible to extract, as the extracted network, a network that includes the nodes that have a non-zero possibility of influencing the influenced entity.

The finishing conditions in this context may be that for every new node that has been added to the extracted network, there exists no upper-level node that is directly linked to that node. In this manner, all the entities that have a path to the influenced entity, including those which have a long path to the influenced entity, are added to the extracted network. Alternatively, upon executing the node addition process for a prescribed number of times, the influence level calculation unit 112 may determine that the finishing conditions have been satisfied, in which case the extracted network includes the entities that are up to a prescribed number of hierarchical levels above the influenced entity.

Next, in step S202, the influence level calculation unit 112 calculates the influence level for the extracted network. For instance, the influence level calculation unit 112 calculates the NPI as an influence level by performing the process described above with reference to FIGS. 8 and 9 on the extracted network. The influence level here is calculated without taking the strategy employed by strategy implementing entity into account. The influence level prior to the implementation of the strategy will be referred to as the first influence level throughout the following description. For instance, the influence level calculation unit 112 implements a process of calculating NPI(X,Y) for all permutations of two entities X and Y in the extracted network. The first influence level of entity X on entity Y will be denoted by NPI_BEFORE(X,Y) throughout the following description.

The influence level calculation unit 112, in step S203, calculates the influence level by taking into account the constraints described above with reference to FIGS. 15A to 16B. The influence level here is calculated by taking into account the strategy implemented by the strategy implementing entity. The influence level after a strategy is implemented will be referred to as the second influence level throughout the following description. For instance, the influence level calculation unit 112 implements a process of calculating NPI(X,Y) for all permutations of two nodes X and Y in the extracted network after incorporating constraints. The second influence level of entity X on entity Y will be denoted by NPI_AFTER(X,Y) throughout the following description.

### Step S109: Evaluation of Strategy

The evaluation processing unit 115 implements a process of evaluating the selected strategy on the basis of the first influence level and the second influence level. For instance, the evaluation processing unit 115 may calculate a difference between the first influence level of the strategy implementing entity on the influenced entity prior to the implementation of the strategy and the second influence level of the strategy implementing entity on the influenced entity subsequent to the implementation of the strategy. For instance, letting entity A be the strategy implementing entity and entity B be the influenced entity, the evaluation processing unit 115 may calculate Δ(A,B) by equation (2) below. Δ(X,Y) denotes a change in the influence level of entity X on entity Y that occurs over the implementation of the strategy.

Δ(A,B)=NPI_AFTER(A,B)−NPI_BEFORE(A,B) (2)

The evaluation processing unit 115 determines that the strategy is more effective when the influence level exhibits a greater magnitude of increase. For instance, the evaluation processing unit 115 may determine that the strategy is effective when Δ(A,B) has a value greater than or equal to a given threshold value that is greater than 0.

Alternatively, the evaluation processing unit 115 may evaluate in relation to changes in the influence level of another entity on the influenced entity. As described above with reference to FIGS. 8 and 9, for example, the influence level calculation unit 112 is capable of calculating the influence level on the influenced entity of every entity in the extracted network except for the influenced entity. Accordingly, the following description assumes that the first influence level and the second influence level of each entity on the influenced entity are already calculated.

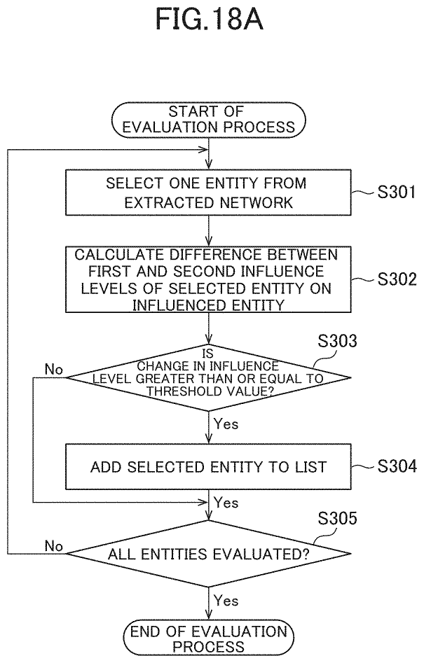

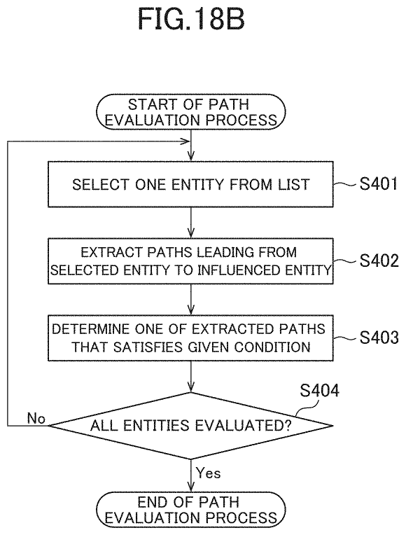

FIG. 18A is a flow chart representing an evaluation process implemented by the evaluation processing unit 115 in step S109. First of all, in step S301, the evaluation processing unit 115 selects any one of entities from those which are in the extracted network.

For instance, let X1 to Xn denote respective entities in the extracted network except for the influenced entity (entity B), where n is an integer greater than or equal to 2. The evaluation processing unit 115 selects entity Xi in step S301, where i is an integer from 1 to n, both inclusive.

In step S302, the evaluation processing unit 115 calculates a change in the influence level of selected entity Xi on the influenced entity on the basis of the first influence level and the second influence level. Specifically, the evaluation processing unit 115 calculates Δ(Xi,B) by subtracting NPI_BEFORE(Xi,B) from NPI_AFTER(Xi,B) similarly to equation (2) above.

In step S303, the evaluation processing unit 115 determines whether or not the magnitude of change in the influence level is greater than or equal to a threshold value. For instance, the evaluation processing unit 115 calculates the absolute value of Δ(Xi,B). The evaluation processing unit 115 determines that the change in the influence level is greater than or equal to a threshold value when the absolute value is greater than or equal to a given threshold value that is greater than 0.

When the change in the influence level is greater than or equal to the threshold value, the evaluation processing unit 115, in step S304, implements a process of adding selected entity Xi to a list.

In step S305, the evaluation processing unit 115 determines whether or not the process has been performed on all the entities in the extracted network. If there remains an unprocessed entity, the evaluation processing unit 115 returns the process to step S301 to implement the process on the other entities. If the process has been completely performed on all the entities, the evaluation processing unit 115 terminates the process shown in FIG. 18A and outputs the generated list to the presentation processing unit 116. This list is a list of entities the influence level of which on the influenced entity significantly changes when the strategy implementing entity implements a strategy.

The evaluation processing unit 115 may implement the process shown in FIG. 18B after the processing shown in FIG. 18A. First of all, in step S401, the evaluation processing unit 115 selects an entity from the list generated in the process shown in FIG. 18A. As an example, let X1′ to Xm′ denote entities on the list, where m is an integer from 1 to n, both inclusive. X1′ to Xm′ correspond respectively to those of X1 to Xn which satisfy the conditions in step S303. The evaluation processing unit 115 selects entity Xj′ in step S401, where j is an integer from 1 to m, both inclusive.

In step S402, the evaluation processing unit 115 extracts, from the extracted network, a path that starts at selected entity Xj′ and ends at the influenced entity. There can be one or more such paths.

In step S403, the evaluation processing unit 115 selects a critical path that satisfies given conditions from the extracted one or more paths. The critical path is, for example, one of the extracted paths that has the shortest path length. The path length in this context is, for example, the number of nodes on the path and may be a distance determined on the basis of some kind of weighting. The critical path may be determined on the basis of the influence levels of the entities on the path. For instance, the evaluation processing unit 115 selects, as the critical path from all the extracted paths, a path the product of all the influence levels of the entities on which is largest. The influence level in this context may be, for example, Δ(Xi,B), which is a change in the influence level of an entity on the influenced entity, NPI_AFTER(Xi,B), which is the influence level subsequent to the implementation of the strategy, or another influence level.

In step S404, the evaluation processing unit 115 determines whether or not the process has been performed on all the entities on the list. If there remains an unprocessed entity, the evaluation processing unit 115 returns the process to step S401 to implement the process on the other entities. If the process has been completely performed on all the entities, the evaluation processing unit 115 terminates the process shown in FIG. 18B. The process shown in FIG. 18B associates each entity on the list to a critical path leading from that entity to the influenced entity.

### Step S110: Presentation Process

In step S110, the presentation processing unit 116 implements a process of presenting a result of the evaluation performed by the evaluation processing unit 115 to the user.

For instance, the presentation processing unit 116 implements a process of causing the display unit 240 of the terminal device 200 to display the value of Δ(A,B) calculated by equation (2) above. In this manner, it is possible to present the user a change in the influential power of the strategy implementing entity on the influenced entity in an easy-to-understand manner. For instance, the user can determine whether or not the selected strategy is suitable, on the basis of whether Δ(A,B) is positive or negative and/or whether Δ(A,B) has a large or small value. Information on how the implementation of the strategy by the strategy implementing entity has changed the influence levels of the other entities in the entity network 121 is also useful in evaluating the strategy. The presentation processing unit 116 may therefore present some information related to the influence levels of the other entities.

For instance, on the basis of the first influence level and the second influence level, the presentation processing unit 116 may implement a process of presenting a fourth entity that is one of the entities that exhibits a change in the influence level thereof on the influenced entity (second entity) when the strategy implementing entity (first entity) takes the actions corresponding to the selected strategy, the change being greater than or equal to a given threshold value.

For instance, assume that the process shown in FIG. 18A, implemented by the evaluation processing unit 115, has determined that three entities X1′, X2′, and X3′ exhibit a large change in the influence level thereof over the implementation of the strategy by the strategy implementing entity. In this situation, the presentation processing unit 116 implements a process of presenting entities X1′ to X3′ to the user. The presentation processing unit 116 may display a list of the names of the three entities.

Alternatively, the presentation processing unit 116 may display the fourth entity in such a form that the fourth entity can be identified in the entity network 121. The entities that exhibit a large change in the influence level thereof can be hence shown on the entity network 121. It is therefore possible to visualize links of the entity to other entities.

FIG. 19 shows an exemplary screen to be presented by the presentation processing unit 116. In FIG. 19, B denotes the influenced entity, and X1′ to X3′ denote entities that exhibit a change in the influence level thereof that is greater than or equal to a threshold value. For instance, letting th1 be a given positive threshold value, Δ(X1′,B)>th1. Similarly, Δ(X2′,B)>th1, and Δ(X3′,B)<−th1.

In FIG. 19, X1′ to X3′ are represented, for example, by nodes displayed in a given form. For instance, the presentation processing unit 116 displays X1′ and X2′, the influence levels of which have significantly increased, in a first form differently from the other nodes and displays X3′, the influence level of which has significantly decreased, in a second form. The presentation processing unit 116 determines a display form on the basis of, for example, the color and size of the node and the color and size of text.

The presentation processing unit 116 may present the critical path, which is one of the paths leading from the fourth entity to the second entity, in such a form that the critical path can be identified. The critical path is determined on the basis of, for example, either one or both of the path length or the influence levels of the entities on the path as described above. In this manner, it is possible to graphically show, in an easy-to-understand manner, through what paths the entities that exhibit a large change in the influence level thereof influence the influenced entity.

The example shown in FIG. 19 shows a path including X2 for entity X1′, a path including X3 for entity X2′, and a path including X4 for entity X3′.

The presentation processing unit 116 may alternatively implement a process of displaying the entities directly linked to the influenced entity regardless of a change in the influence level thereof, as shown in FIG. 19. In the example shown in FIG. 19, there are five entities X1 to X5 that are directly linked to entity B, which is the influenced entity. The presentation processing unit 116 displays the five nodes corresponding to X1 to X5. In this manner, it becomes possible to visualize the direct investment relationships with the influenced entity.

The presentation processing unit 116 may further implement a process of displaying nodes corresponding to the entities other than the fourth entities (X1′ to X3′) in a form determined in accordance with a change in the influence level. For instance, the node representing an entity that exhibits a small increase in the influence level is displayed in a third form, and the node representing an entity that exhibits a small decrease in the influence level is displayed in a fourth form. For instance, entity Xi that satisfies th2<Δ(xi,B)≤th1 is determined to exhibit a small increase in the influence level and displayed in the third form, and entity Xi that satisfies −th1≤Δ(Xi,B)<−th2 is determined to exhibit a small decrease in the influence level and displayed in the fourth form, where a second threshold value th2 satisfies 0<th2<th1.

The presentation processing unit 116 may display the entity that exhibits a very small change in the influence level in a fifth form. For instance, entity Xi that satisfies −th2≤Δ(Xi,B)≤th2 is determined to exhibit a very small change in the influence level and displayed in the fifth form.

A node corresponding to the first form may be displayed in thick red, and a node corresponding to the second form may be displayed in thick blue. Likewise, a node corresponding to the third form may be displayed in light red, a node corresponding to the fourth form may be displayed in light blue, and a node corresponding to the fifth form may be displayed in white. By thus displaying an increase or decrease in the influence level by means of hue and displaying the magnitude of change in the influence level by means of either saturation or luminosity, or both, it is possible to visualize changes in the influence level in an easy-to-understand manner. The display form is not necessarily limited to these examples and may be modified in various manners so long as the modified display form is capable of displaying an increase or decrease in the influence level and the magnitude thereof.

The effectiveness of a national or business strategy can be evaluated from various viewpoints. Evaluation from the viewpoint of “capital controlling power” based on investment relationships has a significant meaning in measuring the specific effects of a strategy. The technique in accordance with the present embodiment described so far enables an appropriate appreciation of investment relationships and an evaluation of strategy-induced changes in such relationships even when the investment relationships have grown highly complex.

In doing so, it is possible to present a strategy that can be implemented by a strategy implementing entity in an easy-to-understand manner by presenting a plurality of strategies as shown in FIG. 11C. For instance, it becomes possible to evaluation a strategy that is worth evaluating, by extracting and presenting strategies that are suited to the strategy implementing entity. It also becomes possible to incorporate the user's intention into the selection of strategies, by receiving the selection of any of the presented strategies.

Furthermore, as shown in FIGS. 15A to 16B, it becomes possible to appropriately incorporate the strategy-induced changes into the influence level calculation process, by appropriately interpreting a selected strategy into the form of constraints. It is also possible to facilitate the user's understanding of the results of the evaluation of a strategy by visualizing the results of the evaluation as shown in, for example, FIG. 19.

Particularly, NPI-based techniques can take into account even indirect relationships such as “investments by a subsidiary company of a subsidiary company” and a “client entity of a client entity of a client company.” In doing so, the technique in accordance with the present embodiment shown in, for example, FIG. 19 can present the change in the influence level of an entity far removed from the influenced entity and present a specific path to the influenced entity. It is therefore possible to visualize the result of the quantitative evaluation that takes into account as much as the indirect relationships above, including links over the network, in an easy-to-understand manner.

Part or large part of the processing implemented by the information processing system 10 in accordance with the present embodiment may be provided by a program. In such cases, the information processing system 10 in accordance with the present embodiment is provided by a processor, such as a CPU, running a program. Specifically, a program stored in a non-transitory information recording medium is retrieved, and the retrieved program is run by a processor such as a CPU. An information recording medium (computer-readable medium) contains, for example, programs and data, and the functions thereof can be provided by, for example, an optical disc, a HDD, or a memory. The CPU or like processor implements various processes in accordance with the present embodiment on the basis of the program stored in the information recording medium. In other words, the information recording medium contains programs for causing a computer (device including an operation unit, a processing unit, a memory unit, and an output unit) to function as the units in accordance with the present embodiment.

The technique in accordance with the present embodiment is applicable to an information processing method in which each of the following steps is performed. The information processing method includes: obtaining an entity network of nodes corresponding to respective entities including a first entity and a second entity based on an investment relationship; presenting strategies representing future actions taken by the first entity that is a given business or a given country; receiving a selection of any of the presented strategies to determine a selected strategy; determining a constraint based on the selected strategy; calculating, based on the entity network, a first influence level that is an influence level on the second entity under no constraint; calculating, based on the entity network, a second influence level that is an influence level on the second entity under the constraint; and evaluating the selected strategy based on a comparison between the first influence level and the second influence level.

### 3. Variation Examples

### 3.1 Variation Examples Related to Flow of Process

The description has so far discussed an example where the strategy determining unit 113 receives a selected strategy and thereafter receives a selection of a strategy target entity in that strategy as shown in steps S105 and S106 in FIG. 10. Since the candidates for the strategy target entity are narrowed down in accordance with the strategy, for example, the strategy determining unit 113 may implement a process of extracting and presenting the candidates. The sequence of processes is however not necessarily limited to this example.

For instance, after an input of a strategy target entity is received, selectable strategies may be presented and received. In such a case, the strategy determining unit 113 may implement a process of narrowing down selectable strategies in accordance with the relationships between the strategy implementing entity and the strategy target entity. For instance, when the strategy implementing entity owns no shares of the strategy target entity, the divestiture strategy may be excluded from the candidates to be presented to the user because it is impossible to implement the divestiture strategy. When the strategy implementing entity owns more than half the shares of the strategy target entity, a hostile strategy will be an unreasonable choice, and a deliberate cooperative strategy may be meaningless. Therefore, in such a case, the strategy determining unit 113 may exclude a hostile strategy and a cooperative strategy from the candidates to be presented to the user.

FIG. 10 is a mere example of the process. The specific flow of the process may be modified in various manners, for example, by receiving a selected strategy implementing entity after receiving a selected influenced entity.

### 3.2 Variation Examples Related to Evaluation Process and Presentation Process

Referring to FIGS. 18A to 19, the description has so far discussed an example where the evaluation process and the presentation process are performed on the basis of the first influence level and the second influence level of each entity on the influenced entity, with the influenced entity, which is an entity that is influenced, being fixed. In this example, with entity B being the influenced entity, the evaluation processing unit 115 evaluates on the basis of, for example, Δ(A,B), which is the difference between NPI_AFTER(A,B) and NPI_BEFORE(A,B), and Δ(Xi,B), which is the difference between NPI_AFTER(Xi,B) and NPI_BEFORE(Xi,B). The technique in accordance with the present embodiment is however not necessarily limited to this example.

As an alternative example, an entity may be selected that influences other entities, so that the evaluation process and the presentation process may be performed on the basis of the first influence level and the second influence level of the selected entity on the other entities. A description is given below of an example where the strategy implementing entity is used as the entity that influences other entities. In this manner, it becomes possible to evaluate how the influence level of a given country or business can change upon the adoption of a strategy by the country or business. The entity that influences other entities may be selected from entities other than the strategy implementing entity.

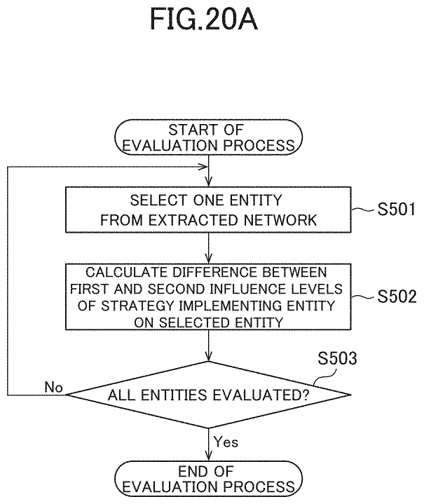

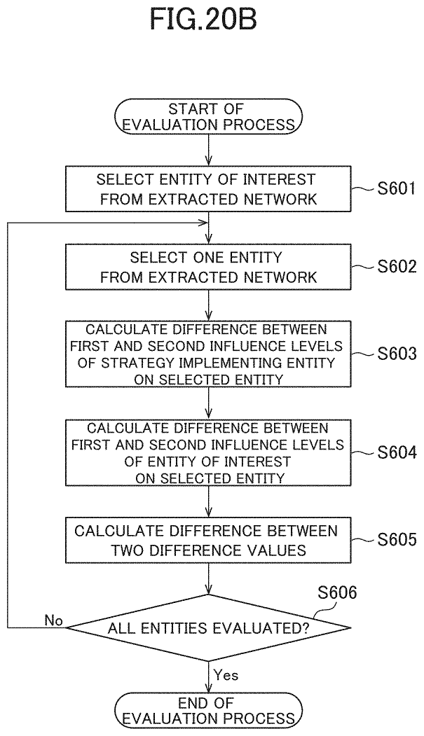

FIG. 20A is a flow chart representing a process performed by the evaluation processing unit 115. Assume, similarly to FIG. 10, that the first influence level and the second influence level are calculated by the influence level calculation unit 112 before the evaluation processing unit 115 performs the process. For instance, the first influence level and the second influence level are calculated for the extracted network that includes the influenced entity as a starting point.

In step S501, the evaluation processing unit 115 selects any one of the entities in the extracted network. For instance, letting entity A be the strategy implementing entity, entity B be the influenced entity, and X1 to Xn denote the other entities, the evaluation processing unit 115 selects Xi, where n is an integer greater than or equal to 2, and i is an integer from 1 to n, both inclusive, similarly to the above-described example.

In step S502, the evaluation processing unit 115 calculates, as a magnitude of change in the influence level, a difference between the first influence level and the second influence level of the strategy implementing entity on selected entity Xi. The evaluation processing unit 115 calculates Δ(A,Xi) by subtracting NPI_BEFORE(A,Xi) from NPI_AFTER(A,Xi).

In step S503, the evaluation processing unit 115 determines whether or not the process has been performed on all the entities in the extracted network. If there remains an unprocessed entity, the evaluation processing unit 115 returns the process to step S501 to implement the process on the other entities. Δ(A,X1) to Δ(A,Xn) are calculated in this manner. If the process has been completely performed on all the entities, the evaluation processing unit 115 terminates the process shown in FIG. 20A and outputs calculated Δ(A,X1) to Δ(A,Xn) to the presentation processing unit 116.

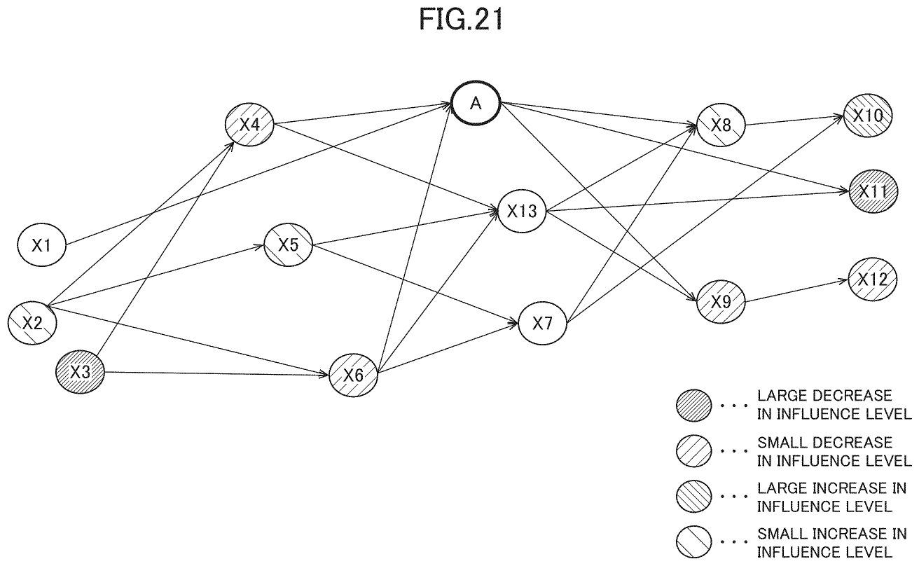

FIG. 21 shows an exemplary screen presented by the presentation processing unit 116 on the basis of the evaluation process shown in FIG. 20A. Entity A in FIG. 21 corresponds to the strategy implementing entity, and X1 to X13 denote entities other than the strategy implementing entity.

Referring to FIG. 21, the presentation processing unit 116 may visualize an increase, a decrease, or no change in the influence level and the magnitude of that increase or decrease for each entity other than the strategy implementing entity. In the example shown in FIG. 21, similarly to FIG. 19, the node corresponding to the entity that exhibits a large magnitude of increase in the influence level is displayed in the first form, and the node corresponding to the entity that exhibits a large magnitude of decrease in the influence level is displayed in the second form. Additionally, the node corresponding to the entity that exhibits a small magnitude of increase in the influence level is displayed in the third form, the node corresponding to the entity that exhibits a small magnitude of decrease in the influence level is displayed in the fourth form, and the node corresponding to the entity that exhibits an almost zero magnitude of change in the influence level is displayed in the fifth form. The display forms may be modified in various manners similarly to FIG. 19.

How the influence level of the strategy implementing entity (entity A) on the other entities (entities XI to Xn) changes as a result of performing the evaluation process shown in FIG. 20A and the presentation process shown in FIG. 21 can be visualized in an easy-to-understand manner by using the entity network 121. Consequently, what effects the evaluated strategy brings to the strategy implementing entity can be presented in an easy-to-understand manner to the user.

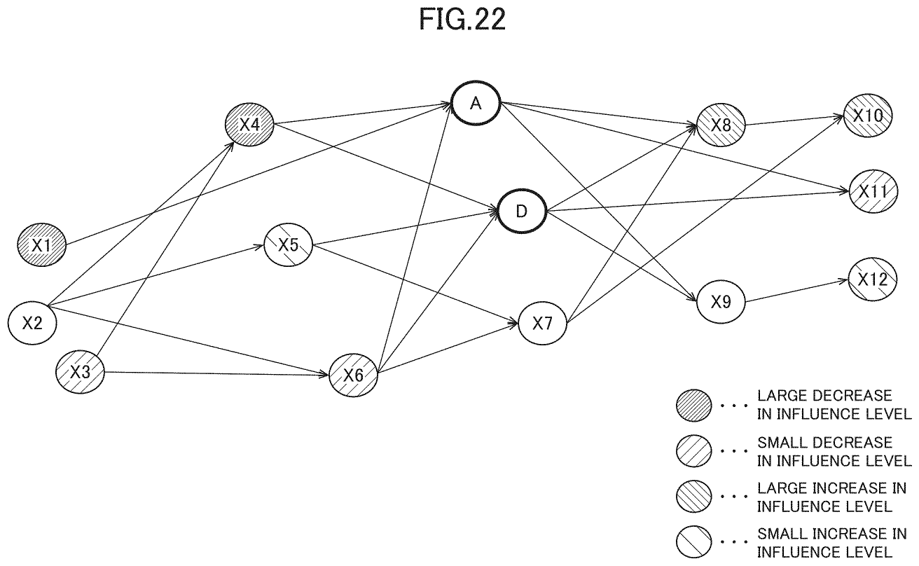

Of the entities in the entity network 121, an entity that is neither the strategy implementing entity (first entity) nor the influenced entity (second entity) is referred to as an entity of interest (fifth entity). In this context, the relative influence level calculated on the basis of the influence level of the strategy implementing entity on the other entities and the influence level of the entity of interest on the other entities is referred to as the relative influence level. The relative influence level is, for example, the difference between the two influence levels as will be described later using equation (3) below, but is not necessarily limited to this. For instance, the relative influence level may be the ratio of the two influence levels or any other information. The presentation processing unit 116 may display a change in the relative influence level on the basis of the first influence level and the second influence level. A detailed description is given in detail below with reference to FIGS. 20B and 22. In this manner, it becomes possible to more appropriately evaluate whether or not a strategy is effective and to present a result of the evaluation by using changes in the relative influence level.

FIG. 20B is a flow chart representing another process performed by the evaluation processing unit 115. In step S601, the evaluation processing unit 115 selects an entity of interest from the entities in the extracted network. For instance, the evaluation processing unit 115 may receive a user operation of selecting an entity of interest. The entity of interest in this context is an entity that interests the strategy implementing entity and is, for example, an entity that confronts the strategy implementing entity.

As an example, let entity A be the strategy implementing entity, entity B be the influenced entity, entity D be an entity of interest, and X1 to Xn denote the other entities. The strategy target entity is depicted as entity C in, for example, FIG. 15A, and the entity of interest is referred to as entity D in the following, which does not necessarily mean that the strategy target entity and the entity of interest are different entities. For instance, in the technique in accordance with the present embodiment, a single entity may double as the strategy target entity and an entity of interest. For instance, when entity A adopts a hostile strategy against entity C, either entity C or another entity may be selected as the entity of interest described below.

In step S602, the evaluation processing unit 115 selects any one of the entities in the extracted network. For instance, the evaluation processing unit 115 selects entity Xi.

In step S603, the evaluation processing unit 115 calculates, as a magnitude of change in the influence level, a difference between the first influence level and the second influence level of the strategy implementing entity on selected entity Xi. Specifically, the evaluation processing unit 115 calculates Δ(A,Xi) by subtracting NPI_BEFORE(A,Xi) from NPI_AFTER(A,Xi).

In step S604, the evaluation processing unit 115 calculates, as a magnitude of change in the influence level, a difference between the first influence level and the second influence level of the entity of interest on selected entity Xi. Specifically, the evaluation processing unit 115 calculates Δ(D,Xi) by subtracting NPI_BEFORE(D,Xi) from NPI_AFTER(D,Xi).

In step S605, the evaluation processing unit 115 calculates a difference between the difference value calculated in step S603 and the difference value calculated in step S604. For instance, the evaluation processing unit 115 calculates Δ(Xi) by equation (3) below.

Δ(Xi)=Δ(A,Xi)−Δ(D,Xi) (3)

In step S606, the evaluation processing unit 115 determines whether or not the process has been performed on all entities X1 to Xn. If there remains an unprocessed entity, the evaluation processing unit 115 returns the process to step S602 to implement the process on the unprocessed entity. In other words, the evaluation processing unit 115 calculates Δ(X1) to Δ(Xn). If the process has been completely performed on all the entities, the evaluation processing unit 115 terminates the process shown in FIG. 20B and outputs calculated Δ(X1) to Δ(Xn) to the presentation processing unit 116.

For instance, when entity A, which is the strategy implementing entity, is confronting entity D, which is an entity of interest, the change in the influence level of entity D on the other entities is also important in the evaluation of a strategy. For instance, even when the influence level of entity A on given entity Xi increases due to a strategy, entity A is at a disadvantage over entity D in the competition for entity Xi if the influence level of entity D on entity Xi increases more than the influence level of entity A on entity Xi does. In contrast, even when the influence level of entity A on entity Xi decreases due to a strategy, entity A is at an advantage over entity D in the competition for entity Xi if the influence level of entity D on entity Xi decreases more than the influence level of entity A on entity Xi does. In other words, when Δ(Xi) is positive, Δ(Xi) indicates that the relative influence level of entity A has increased; and when Δ(Xi) is negative, Δ(Xi) indicates that the relative influence level of entity A has decreased.

Referring to FIG. 20B, it becomes possible to evaluate a strategy on the basis of a change in the relative influence level between the strategy implementing entity and an entity of interest, by performing an evaluation process using Δ(D,Xi) as well as Δ(A,Xi).

FIG. 22 shows an exemplary screen presented by the presentation processing unit 116 on the basis of the evaluation process shown in FIG. 20B. Entity A in FIG. 22 corresponds to the strategy implementing entity, and entity D corresponds to the entity of interest. FIG. 21 represents a part of the entity network 121, and X1 to X12 denote the entities other than the strategy implementing entity and the entity of interest in that part of the network.

Referring to FIG. 22, the presentation processing unit 116 may visualize an increase, a decrease, or no change in the influence level and the magnitude of that increase or decrease for entities X1 to X12 on the basis of the values of Δ(X1) to Δ(X12). The display method may be modified in various manners similarly to FIGS. 19 and 21. For instance, the presentation processing unit 116 may show paths leading from those of entities X1 to Xn which exhibit an amount of change in excess of a threshold value th1 to entity A and entity B in a diagrammatic form. The presentation processing unit 116 may alternatively display the nodes corresponding respectively to X1 to Xn in forms that match an increase, a decrease, or a magnitude of change in Δ(Xi).

The evaluation processing unit 115 may calculate a change in the influence level of the strategy implementing entity on the entity of interest (not shown in FIGS. 20B and 22).

For instance, the evaluation processing unit 115 may calculate Δ(A,D) and show Δ(A,D) in a diagrammatic form by subtracting NPI_BEFORE(A,D) from NPI_AFTER(A,D).

Alternatively, the total sum of Δ(Xi) calculated for each entity Xi (X1 to X12 in the example shown in FIG. 21) may be used as an index to evaluate a strategy. For instance, the evaluation processing unit 115 calculates the total sum of Δ(X1) to Δ(Xn) as an index value p.

In other words, Δ(A,D) represents a change in the direct influential power of entity A on entity D. The letter p denotes a change in the relative influential power of entity A and entity D. For instance, the evaluation processing unit 115 may determine that the selected strategy is effective when the two inequalities, Δ(A,D)>0 and p>0, are satisfied.

### 3.3 Suggesting Strategy Target Entity

Referring to steps S105 and S106 in FIG. 10, the description has so far discussed an example where the strategy determining unit 113 receives inputs of a selected strategy and a selected strategy target entity. This process is suitable when the details of the strategy are definite, for example, when one wants to know the effects of cooperating with a particular entity. In some situations, however, it is only the goal that is definite, and one is yet to have a clear, specific strategy for achieving that goal. The goal here may be, for example, to increase one's influence level or decrease the influence level of a hostile entity.

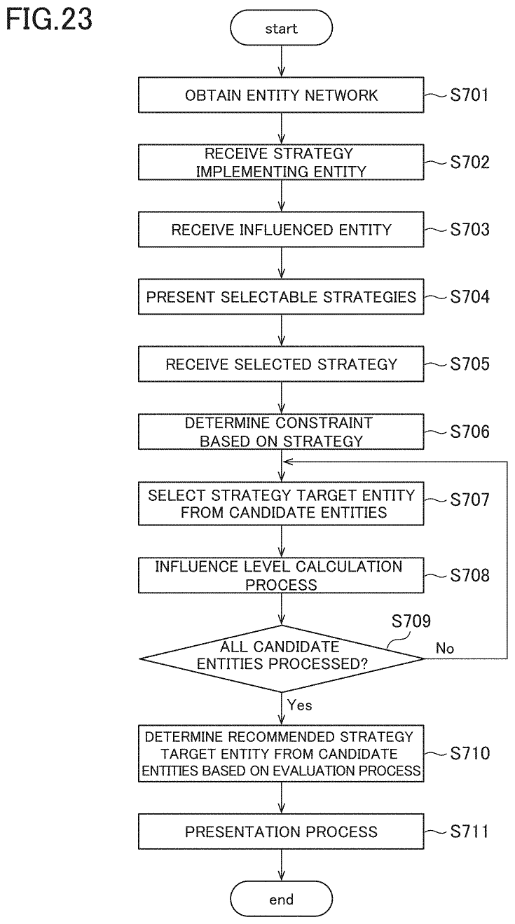

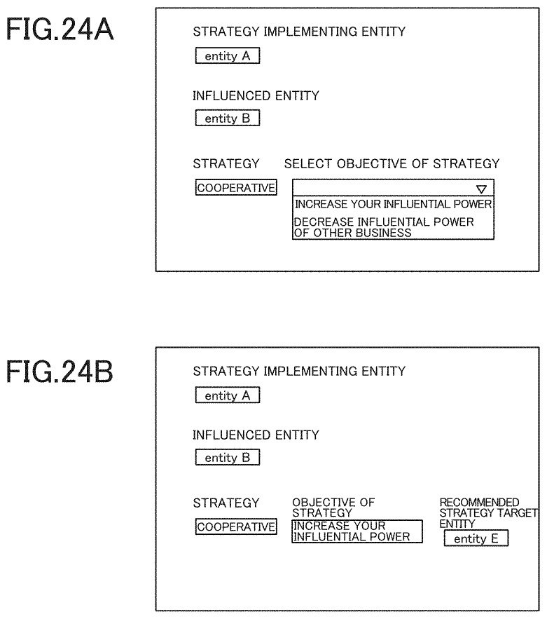

Accordingly, upon the strategy determining unit 113 receiving a selection of any of the strategies, the evaluation processing unit 115 may extract, from a plurality of entities, a plurality of candidate entities that are candidates for the strategy target entity (third entity). The influence level calculation unit 112 calculates the second influence level that each of the candidate entities will have when the candidate entity is designated as the strategy target entity. The evaluation processing unit 115 implements a process of selecting the third entity from the candidate entities on the basis of a process of comparison between the first influence level and the second influence level. In this manner, it is possible for the information processing system 10 to assist in selecting a strategy target entity. For instance, the information processing system 10 can present an appropriate result of evaluation to the user even in an initial stage of devising of a strategy when details are yet to be defined. A detailed description is given below with reference to FIGS. 23 and 24.

FIG. 23 is a flow chart representing a process of automatically determining a strategy target entity. Steps S701 to S706 in FIG. 23 are the same as steps S101 to S105 and S107 in FIG. 10, and their description is therefore omitted.

In step S707, the evaluation processing unit 115 obtains a plurality of candidate entities. For instance, the evaluation processing unit 115 may designate, as candidate entities, all the entities in the extracted network except for the strategy implementing entity and the influenced entity and may designate some of these entities as candidate entities. Alternatively, the evaluation processing unit 115 may receive a candidate entity selection operation from the user. The evaluation processing unit 115 implements a process of selecting one of the candidate entities as a tentative strategy target entity.

In step S708, the influence level calculation unit 112 implements a process of calculating the first influence level. In step S708, the influence level calculation unit 112 implements a process of calculating the second influence level by using the selected tentative strategy target entity. The process here is the same as process described above with reference to FIG. 17. Since the first influence level is fixed for all the strategy target entities, the process of calculating the first influence level needs to be implemented only once.

In step S709, the evaluation processing unit 115 determines whether or not the process has been performed on all the candidate entities. If there remains an unprocessed entity, the evaluation processing unit 115 returns the process to step S707 to select another candidate entity as a tentative strategy target entity.

If the process has been completely performed on all the candidate entities, the evaluation processing unit 115, in step S710, determines a recommended strategy target entity from the candidate entities by implementing an evaluation process on the basis of a result of the calculation of the influence level. For instance, the evaluation processing unit 115 may calculate an evaluation value that each of the candidate entities will have when the candidate entity is designated as the strategy target entity, to designate the candidate entity with a large evaluation value as a recommended strategy target entity.

More specifically, letting entity A be the strategy implementing entity and entity B be the influenced entity, the evaluation processing unit 115 may calculate Δ(A,B) by subtracting NPI_BEFORE(A,B) from NPI_AFTER(A,B), to designate the candidate entity with a maximum Δ(A,B) value as a recommended strategy target entity. Alternatively, the evaluation processing unit 115 may identify an entity of interest D as described earlier with reference to FIGS. 20B and 22 and calculate an index value corresponding to Δ(A,D) and p, to designate the candidate entity with a maximum index value as a recommended strategy target entity.

As described in the foregoing, selecting a highly evaluated candidate entity can be a way of determining a recommended strategy target entity. However, the result of evaluation can vary and come out high or low depending on evaluation criteria as demonstrated by the above-described example. For instance, different entirety may be designated as a recommended strategy target entity depending on whether to use Δ(A,B), Δ(A,D), or p.

The evaluation processing unit 115 may therefore determine a selected evaluation criterion by receiving at least one selected evaluation criterion from a plurality of evaluation criteria. The evaluation processing unit 115 implements a process of selecting a strategy target entity (third entity) from a plurality of candidate entities on the basis of a process of comparison under the selected evaluation criterion. The evaluation criteria may include a first evaluation criterion using the magnitude of increase in the influence level of the strategy implementing entity (first entity) and a second evaluation criterion using the magnitude of decrease in the influence level of a hostile entity that confronts the strategy implementing entity. In this manner, it becomes possible to present a suitable recommended strategy target entity to the user because the evaluation criteria that match a user selection are used.

For instance, let entity A be the strategy implementing entity, entity B be the influenced entity, entity D be the entity of interest (hostile entity), and entities X1 to Xn denote other entities. The evaluation value under the first evaluation criterion is a value representing a change in the influence level of entity A, which is a strategy implementing entity, such as Δ(A,B), Δ(A,Xi), or a total sum of Δ(A,X1) to Δ(A,Xn). The first evaluation criterion is such an evaluation criterion that a larger evaluation value indicates a higher evaluation rating.

The evaluation value under the second evaluation criterion is a value representing a change in the influence level of a hostile entity such as Δ(D,B), Δ(D,Xi), or a total sum of Δ(D,X1) to Δ(D,Xn). The second evaluation criterion is such an evaluation criterion that a smaller evaluation value indicates a higher evaluation rating.

Alternatively, the evaluation criteria may include a third evaluation criterion using a change in the relative influence level of two entities. For instance, the evaluation value under the third evaluation criterion is, for example, Δ(Xi) or a total sum of Δ(X1) to Δ(Xn), which appears in equation (3) above. When any of these evaluation values is used, the third evaluation criterion is such an evaluation criterion that a larger evaluation value indicates a higher evaluation rating.

FIG. 24A shows an exemplary display screen for a user input of an evaluation criterion. Referring to FIG. 24A, the display screen shows a list of evaluation criteria and has an area for receiving an operation of selecting one of the evaluation criteria.

In step S711, the presentation processing unit 116 implements a process of presenting a recommended strategy target entity. FIG. 24B shows an exemplary display screen for presenting a recommended strategy target entity in this example. Assume, in this example, that the first evaluation criterion is selected as an evaluation criterion and the evaluation processing unit 115 identifies entity E as a recommended strategy target entity as a result of evaluating each candidate entity under the first evaluation criterion.

The display screen shown in FIG. 24B has an area for displaying a recommended strategy target entity. In this manner, it becomes possible to automatically select a recommended strategy target entity and present the result of the selection in an easy-to-understand manner, without having to receive s selected strategy target entity from the user.

The description has so far discussed an example where the evaluation processing unit 115 automatically determines one recommended strategy target entity as a strategy target entity. The process in accordance with the present embodiment is not necessarily limited to this example. As an alternative example, the evaluation processing unit 115 may determine all the candidate entities that have an evaluation value greater than or equal to a threshold value as recommended strategy target entities. The presentation processing unit 116 may display, for example, a plurality of recommended strategy target entities in such a manner as to receive an operation of selecting one of the displayed recommended strategy target entities.

After the strategy target entity is determined, the process proceeds in the same manner as in FIG. 10, where the evaluation processing unit 115 performs an evaluation process on the basis of the influence level so that the presentation processing unit 116 can present a result of the evaluation. The influence level calculation process corresponding to step S108 in FIG. 10 has been already implemented in step S708. The evaluation process corresponding to step S109 in FIG. 10 has been already implemented in step S710. Therefore, the process in FIG. 23 does not need to perform the influence level calculation process and the evaluation process again. For instance, the presentation processing unit 116 may, in the presentation process in step S711, present a recommended strategy target entity and additionally a result of evaluation based on the recommended strategy target entity. In this example, the display screen may come in various forms and appear like those shown in, for example, FIGS. 19, 21, and 22.

### 3.4 Variation Examples of Entities and Entity Network

The description has so far discussed an example where the entities are people, businesses, and/or countries and the entity network is a network representing dominance relationships between the capital of a plurality of entities. The technique in accordance with the present embodiment however is not necessarily limited to this example.

For instance, the entities in the present embodiment may include operational boards of members. An operational board or a board here is an organized body of people, businesses, and/or countries that allows a decision-making by, for example, people by way of a resolution. Where each entity involved in a resolution has a predetermined number of votes, the influential power of that entity in this context can be evaluated using the Shapley-Shubik index similarly to the example described above.

For instance, when given board A includes a plurality of entities (e.g., people, businesses, or countries), each of these entities has an influential power on board A expressed for example, by the Shapley-Shubik index calculated on the basis of the number of votes that the entity has. When all the entities have an equal number of votes, each entity has the same Shapley-Shubik index. In other words, it becomes possible to evaluate, for example, how influential power changes between boards of members due to a strategy employed by, for example, given people and businesses on the boards, by obtaining an entity network that includes the boards as entities and implementing the same process on the basis of the entity network as in the above-described example.

Assume that person “a” on board “A” also sits on board “B,” that person “a” is, for example, a representative of board A, and also that person “a” acts on the basis of an opinion that reflects the resolution of board A in making a resolution in board B. In such a situation, the resolution of board A can influence the resolution of board B. In other words, board A has influential power over board B. In other words, it becomes possible to find out how influential power changes between boards of members due to a strategy employed by a given board, by obtaining an entity network that includes the board as an entity and implementing the same process on the basis of the entity network as in the above-described example.

For instance, the server system 100 generates nodes corresponding to boards on the basis of public information. When the server system 100 handles boards as targets, the attribute of the nodes may include, for example, information on people who belong to the target board and information representing a representative of the board. If an entity on board A also sits on board B, the two nodes corresponding to boards A and B are linked by an directional edge because board A and board B have a relationship. If the representative of board A also sits on board B, the two nodes are linked by an edge pointing from board A to board B.

For instance, when person “a” on board “A” also sits on board “B,” and each member of board B is given a single vote in a ballot, the influential power of board A on board B is calculated on the basis of that number of votes that board A has (one vote). Note that when two or more people on board A also sit on board B, and these people act in a cooperative manner on the basis of the resolution of board A, the influential power of board A on board B may be calculated on the basis of the total number of votes of the people.

The present variation example enables evaluating what strategy will bring in a desirable result, for example, in a standardization body that is a group of businesses and in an international organization of countries. The present variation example further enables evaluating how a strategy related to a given board will, for example, influence another board of members. A strategy can be hence devised in view of complex relationships between entities, for example, evaluating a strategy that is advantageous in a given board as being unfavorable in a bigger picture because the strategy is disadvantageous in another board.

### 3.5 Variation Examples Related to Number and Combinations of Strategy Target Entities

The description has so far discussed an example where there is involved a single strategy target entity. In real situations, however, an entity may employ a strategy to cooperate with a plurality of groups of businesses or to confront a plurality of groups of businesses. Additionally, a given business may simultaneously employ a cooperative strategy and a hostile strategy by cooperating with one or more businesses and confronting another or other businesses.

Accordingly, in the present embodiment, two or more entities may be designated as strategy target entities. For instance, when a strategy implementing entity employs a cooperative strategy with a plurality of strategy target entities, entity C in Cooperative Constraints 1 to 3 listed again below needs only to be extended to a plurality of entities. Specifically, when only the strategy implementing entity matches certain Qs, a process is performed under Cooperative Constraint 1; when only one of strategy target entities is matches certain Qt, a process is performed under Cooperative Constraint 2: and when two or more of the strategy implementing entity and strategy target entities match two or more of Q1, . . . , Qk respectively, a process is performed under Cooperative Constraint 3. There may be three or more entities that match three or more of Q1, . . . , Qk respectively, in which case the total shareholding ratio is equal to the sum of the shareholding ratios of the three or more entities.

Cooperative Constraint 1: if only entity A matches certain Qs, Qs is rewritten as A&C, and the shareholding ratio thereof is set to qs, where s is an integer greater than or equal 1 and less than or equal to k.

Cooperative Constraint 2: If only entity C matches certain Qt, Qt is rewritten as A&C, and the shareholding ratio thereof is set to qt, where t is an integer greater than or equal 1 and less than or equal to k.

Cooperative Constraint 3: If entity A and entity C match Qs and Qt respectively. Qs and Qt are deleted, A&C is inserted, and the shareholding ratio of A&C is set to qs+qt.

The same description applies to cases where a strategy other than a cooperative strategy is employed. In other words, the strategy target entity is extended to two or more strategy target entities under the hostile constraints, the takeover constraints, and the divestiture constraints described above. In this manner, it becomes possible to evaluate a strategy in an appropriate manner even when there are two or more strategy target entities.

When two or more strategies of different types are combined, the processes expressing the corresponding constraints are performed. For instance, when a strategy is employed to cooperate with given group of businesses A and confront other group of businesses B, Cooperative Constraints 1 to 3 are performed with the businesses in group of businesses A being designated as entity C, and Hostile Constraints 1 to 3 are performed with the businesses in group of businesses B being designated as entity C. In this manner, it becomes possible to evaluate a strategy in an appropriate manner even when two or more strategies are performed together. There may be two or more strategy target entities involved in each strategy here.

The present embodiment has been discussed in detail. A person skilled in the art will readily appreciate that numerous modifications can be made without substantially departing from the new matter and effects of the present embodiment. Accordingly, all such modifications are included in the scope of the present disclosure. For example, terms that appear at least once in the description or drawings along with other broader or synonymous terms can be replaced by those other terms in any part of the description or drawings. Also, all the combinations of the present embodiment and the modifications are encompassed in the scope of the present disclosure. Also, the configurations and operations of the information processing system, the server system, and the terminal device, among others, are not limited to those described in the present embodiment, and various modifications can be made.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An information processing system comprising:
an entity network obtaining unit configured to obtain an entity network of nodes corresponding to respective entities including a first entity and a second entity based on an investment relationship;
an influence level calculation unit configured to implement an influence level calculation process of calculating an influence level on the second entity based on the entity network;
a strategy determining unit configured to present strategies representing future actions taken by the first entity and receive a selection of any of the presented strategies to determine a selected strategy;
a strategy interpretation unit configured to determine a constraint for the influence level calculation process based on the selected strategy; and
an evaluation processing unit configured to evaluate the selected strategy based on a result of the influence level calculation process, wherein
the influence level calculation unit calculates a first influence level that is the influence level under no constraint and a second influence level that is the influence level under the constraint, and
the evaluation processing unit evaluates the selected strategy based on a comparison between the first influence level and the second influence level.

2. The information processing system according to claim 1, wherein the strategies include either one or both of a cooperative strategy in which the first entity cooperates with a third entity and a hostile strategy in which the first entity confronts the third entity, the third entity being one of the entities on which the first entity will take the actions.

3. The information processing system according to claim 2, wherein the selectable strategies include a takeover strategy in which the first entity takes over the third entity and a divestiture strategy in which the first entity divests the third entity.

4. The information processing system according to claim 2, wherein in response to the strategy determining unit receiving the selection of any of the presented strategies, the evaluation processing unit extracts candidate entities that are candidates for the third entity from the entities and implements a process of selecting the third entity from the candidate entities based on the comparison between the first influence level and the second influence level that is calculated for each of the candidate entities.

5. The information processing system according to claim 4, wherein
the evaluation processing unit receives a selection of any of evaluation criteria to determine a selected evaluation criterion and implements the process of selecting the third entity from the candidate entities based on the first influence level, the second influence level, and the selected evaluation criterion, and
the evaluation criteria include a first evaluation criterion using a magnitude of increase in the influence level of the first entity and a second evaluation criterion using a magnitude of decrease in the influence level of a hostile entity that confronts the first entity.

6. The information processing system according to claim 1, further comprising a presentation processing unit configured to implement a process of presenting, as a fourth entity, one of the entities the influence level of which on the second entity is determined based on the first influence level and the second influence level to increase to or above a given threshold value when the first entity takes one of the actions that is associated with the selected strategy.

7. The information processing system according to claim 6, wherein the presentation processing unit implements a process of displaying the fourth entity in such a form that the fourth entity can be identified in the entity network.

8. The information processing system according to claim 7, wherein the presentation processing unit presents a critical path that is one of paths leading from the fourth entity to the second entity in an identifiable form, the critical path being determined based on either one or both of a path length and the influence level of each of the entities on the path.

9. The information processing system according to claim 1, further comprising a presentation processing unit configured to implement a process of presenting a change in a relative influence level based on the first influence level and the second influence level, the relative influence level being an influence level that is relative and determined based on the influence level of the first entity and the influence level of a fifth entity that is any one of the entities other than the first entity and the second entity.

10. An information processing method comprising:
obtaining an entity network of nodes corresponding to respective entities including a first entity and a second entity based on an investment relationship;
presenting strategies representing future actions taken by the first entity;
receiving a selection of any of the presented strategies to determine a selected strategy;
determining a constraint based on the selected strategy;
calculating, based on the entity network, a first influence level that is an influence level on the second entity under no constraint;
calculating, based on the entity network, a second influence level that is an influence level on the second entity under the constraint; and
evaluating the selected strategy based on a comparison between the first influence level and the second influence level.
